(19) United States
(12) Patent Application Publication
(10) Pub. No.: US 2017/0235970 A1
(43) Pub. Date: Aug. 17, 2017

(54) SCALABLE DATA VERIFICATION WITH IMMUTABLE DATA STORAGE

(71) Applicant: Daniel Conner, (US)

(72) Inventor: Daniel CONNER, Reston, VA (US)

(21) Appl. No.: 15/429,426

(22) Filed: Feb. 10, 2017

Related U.S. Application Data
(60) Provisional application No. 62/293,954, filed on Feb. 11, 2016.

(51) Int. Cl. G06F 21/62; G06F 21/44; G06F 17/30

(52) U.S. Cl. CPC G06F 21/6227; G06F 17/30368; G06F 21/44

(57) ABSTRACT

The present disclosure relates to providing scalable data verification. In some embodiments, a first device receives first data associated with a second device. The first device determines whether a first hash value generated by hashing the first data matches a second hash value received from the second device. Upon determining that the first and second hash values match, the first device stores the first data and the first hash value to a first data log associated with the second device. The first device determines whether a third hash value generated by hashing the first data log matches a fourth hash value received from the second device. The fourth hash value represents a hash of a second data log at the second device. Upon determining that the third and fourth hash values match, the first device updates a verification log to indicate that the first and second data logs match.

### CROSS-REFERENCE TO RELATED APPLICATIONS

This application claims the benefit of U.S. Provisional Application No. 62/293,954, titled, “Distributed Concurrence Ledger” filed on Feb. 11, 2016, which is herein incorporated by reference in its entirety.

### FIELD OF THE DISCLOSURE

This disclosure relates generally to providing data verification and data storage.

### BACKGROUND OF THE DISCLOSURE

A distributed database is a database in which data storage devices are not all attached to a common processor. Commonly, the distributed database is stored across multiple storage devices at the same physical location or more preferably, dispersed across one or more networks of interconnected storage devices at different physical locations. Storing copies of the database or portions of the database in different storage devices may eliminate a single point-of-failure and may induce both higher availability and increased reliability of stored data.

Currently, blockchain technology—which implements a type of distributed database—is being applied to a variety of applications due to its capabilities to reduce centralized points of vulnerability and to maintain secure, incorruptible databases. In blockchain technology, a system of networked nodes, e.g., computers or servers, each store a copy of the entire distributed database, often referred to as a blockchain. Whenever a group of data records is to be added to the distributed database, i.e., blockchain, each node may independently verify the group of data records in a batch process known as generating a block. In the batch process, a node verifies the group of data records based on its copy of the blockchain storing previously-verified data records. A node that generates the block may transmit the generated block to every other node in the system. In current implementations, only after the block is verified by each node in the system may each node add the block to its copy of the blockchain. As each of the nodes independently verifies the block, blockchain technology may reduce the risk of a single point-of-attack or a single point-of-failure. Further, since a copy of the blockchain is maintained at each node, the data is stored in a redundant manner.

Due to the advantages provided by the blockchain, many entities (e.g., governments, companies, hospitals, banks, etc.) are currently trying to implement blockchain technology in a variety of applications. For example, these applications may relate to cryptocurrencies like Bitcoin, copyright registration, supply chain management, online voting, or medical records management. Other applications may relate generally to data verification such as that used in the corporate environment, retail arena, banking, stock market, etc.

### SUMMARY OF THE DISCLOSURE

As described above, blockchain technology has many applications. However, there is a need for several improvements to blockchain. In blockchain technology, verified blocks are continuously added to the blockchain to maintain data records that are resistant to tampering or corruption. As a result, these blockchains are ever growing in size and are becoming more computationally intensive to process and more bandwidth-intensive to transmit. Further, in current blockchain implementations, batch processing may require a long delay, e.g., ten minutes, to generate a block of a few thousand data records. In practice, however, many applications may require tens of thousands or even hundreds of thousands of data records to be verified and stored every second. Therefore, current blockchain implementations are too slow and not scalable for processing a high volume of data record.

Further, in many of these applications, verified data records may contain sensitive or confidential information between a few entities (e.g., two parties) that should not be viewable by third parties. In current blockchain implementations, however, each node—which may correspond to third parties not privy to the sensitive or confidential information—maintains a copy of the blockchain including all of the previously-verified data records. In addition to obtaining access to sensitive or confidential information in data records, a third-party node may also obtain sensitive business information such as the identities of entities associated with the data record, the volume of data being exchanged between entities, a frequency of the data exchanged, etc.

Accordingly, there is a need for systems, methods, and techniques for verifying data in a scalable manner without exposing data containing sensitive information to third parties and storing verified data redundantly and immutably.

In some embodiments, a non-transitory computer-readable storage medium comprises instructions for providing scalable data verification, wherein the instructions, when executed by a first device having one or more processors, cause the one or more processors to: receive first data associated with a second device; determine whether a first hash value generated by hashing the first data matches a second hash value, wherein the second hash value is received from a second device and represents a hash of second data stored at the second device; in response to determining that the first and second hash values match, store the first data and the first hash value to a first data log at the first device, wherein the first data log is associated with the second device; determine whether a third hash value generated by hashing the first data log matches a fourth hash value, wherein the fourth hash value is received from the second device and represents a hash of a second data log stored at the second device; and in response to determining that the third and fourth hash values match, update a verification log to indicate that the first and second data logs match.

In some embodiments, a system for providing scalable data verification comprises a first device comprising one or more processors, memory, and one or more programs stored in the memory and configured to be executed by the one or more processors where the one or more programs include instructions for: receiving first data associated with a second device; determining whether a first hash value generated by hashing the first data matches a second hash value, wherein the second hash value is received from a second device and represents a hash of second data stored at the second device; in response to determining that the first and second hash values match, storing the first data and the first hash value to a first data log at the first device, wherein the first data log is associated with the second device; determining whether a third hash value generated by hashing the first data log matches a fourth hash value, wherein the fourth hash value is received from the second device and represents a hash of a second data log stored at the second device; and in response to determining that the third and fourth hash values match, updating a verification log to indicate that the first and second data logs match.

In some embodiments, a method performed at a first device to enable scalable data verification comprise: receiving first data associated with a second device; determining whether a first hash value generated by hashing the first data matches a second hash value, wherein the second hash value is received from a second device and represents a hash of second data stored at the second device; in response to determining that the first and second hash values match, storing the first data and the first hash value to a first data log at the first device, wherein the first data log is associated with the second device; determining whether a third hash value generated by hashing the first data log matches a fourth hash value, wherein the fourth hash value is received from the second device and represents a hash of a second data log stored at the second device; and in response to determining that the third and fourth hash values match, updating a verification log to indicate that the first and second data logs match.

### BRIEF DESCRIPTION OF THE DRAWINGS

The foregoing summary, as well as the following detailed description of embodiments, is better understood when read in conjunction with the appended drawings. For the purpose of illustrating the present disclosure, the drawings show example embodiments of the disclosure; the disclosure, however, is not limited to the specific methods and instrumentalities disclosed. In the drawings:

FIG. 1 illustrates a system for facilitating scalable data verification, according to some embodiments;

FIG. 2 illustrates a system including one or more client systems that each implements a verification system to facilitate scalable data verification and redundant, immutable storage of verified data, according to some embodiments;

FIG. 3 illustrates a system including a service system that implements a verification system to facilitate scalable data verification and redundant, immutable storage of verified data, according to some embodiments;

FIG. 4 is a diagram illustrating logs maintained for two entities, according to some embodiments;

FIG. 5A is a diagram illustrating how data logs may be aggregated, according to some embodiments;

FIG. 5B is a diagram illustrating example analysis performed on verified data, according to some embodiments;

FIGS. 6A-B illustrate a method for cooperatively verifying data and facilitating redundant, immutable storage of verified data, according to some embodiments;

FIG. 7 illustrates a method for generating a new data log for immutable storage of verified data, according to some embodiments;

FIG. 8 illustrates components of a verification server, according to some embodiments; and

FIG. 9 illustrates a system including a verification system that verifies and stores data associated with two or more client systems operating separately from the verification system, according to some embodiments;

FIG. 10 illustrates an example of a computer, in accordance with one embodiment.

### DETAILED DESCRIPTION

Described herein are computer-readable storage mediums, systems, and methods for providing scalable data verification. In some embodiments, a first and a second device cooperatively verify data received at the first and second devices. For example, the first device may receive first data associated with the second device and the second device may receive second data associated with the first device. To verify the first data, the first device determines whether a first hash value generated by hashing the first data matches a second hash value received from the second device. The second hash value may represent a hash of second data stored at the second device. In some embodiments, in response to determining that the first and second hash values match, the first device stores the first data and the first hash value to a first data log associated with the second device.

In some embodiments, the first and second devices further cooperatively verify that verified data stored in respective data logs of the first and second devices is stored redundantly and immutably. For example, in some embodiments, the first device determines whether a third hash value generated by hashing the first data log matches a fourth hash value received from the second device. The fourth hash value represents a hash of a second data log stored at the second device. By comparing hashes of the first and second data logs, the first device can determine whether verified data had been stored immutably. This is because any difference in the hashes may indicate that data has been modified in the first data log, the second data log, or both data logs. In response to determining that the third and fourth hash values match, the first device updates a verification log to indicate that the first and second data logs match.

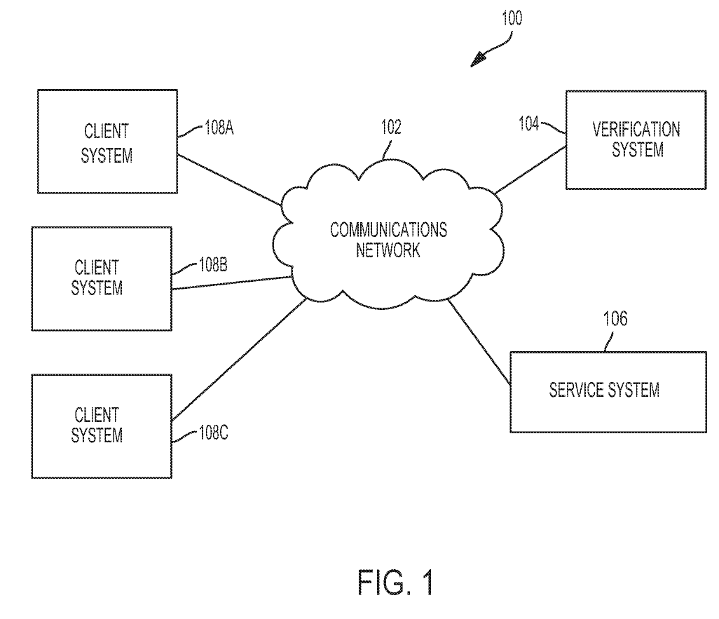

FIG. 1 illustrates a system 100 for facilitating scalable data verification, according to some embodiments. System 100 includes client systems 108A-C that can communicate with each other or a service system 106 via a communications network 102. Also, a verification system 104 may be coupled to client systems 108A-C or service system 106 via communications network 102. Communications network 102 may include a local area network (LAN), a wide area network (WAN), the Internet, a Wi-Fi network, a WiMAX network, a cellular network (e.g., 3G, 4G, 4G Long Term Evolution (LTE)), a cloud network, or a combination thereof. Further, communications network 102 may implement one or more wired and/or wireless standards or protocols.

In some embodiments, service system 106 can be a source of data associated with two or more client systems 108A-C. For example, service system 106 may include a data repository where data associated with client system 108A and 108B is stored. In another example, service system 106 may be an email server enabling, for example, client system 108A to transmit data to client system 108B. In some embodiments, service system 106 generates data based on input from one or more client systems 108A-C. For example, service system 106 may generate data associated with client systems 108A and 108B based on input from client system 108A, client system 108B, or both client systems 108A and 108B. Upon generating the data, service system 106 may transmit a copy of the data to client systems associated with the data, e.g., both client systems 108A and 108B, for collaborative verification and redundant, secure storage. In some embodiments, service system 106 transmits the data to verification system 104 that implements the scalable data verification techniques described below.

In some embodiments, the data is encapsulated within a message (i.e., a sequence of bits) electronically received by two or more of client systems 108A-C. In some embodiments, the message is a file that adheres to a file format. For example, the file format may include an image file format (e.g., PNG, JPEG, or PDF), an audio file format (e.g., WAV, FLAC, MP3, etc.), a video file format (e.g., FLV, AVI, WMV, etc.), a word processing format (e.g., MSWord), or a document format based on one or more Electronic Data Interchange (EDI) standards.

In some embodiments, client systems 108A-C are each associated with a different entity. An entity may include, for example, a government agency, a corporation, an individual user, a utilities company, a bank, a hospital, an organization of companies, etc. Each of client systems 108A-C may include one or more servers for managing data and one or more databases for storing data. One or more client systems 108A-C, however, may offload the functionality of the server(s) and database(s) to a separate system such as a cloud system. In some embodiments, to conduct business between, for example, client systems 108A and 108B, client systems 108A and 108B may exchange data between each other or receive data via service system 106. For example, as discussed above, service system 106 may generate data to be received by each of client systems 108A and 108B.

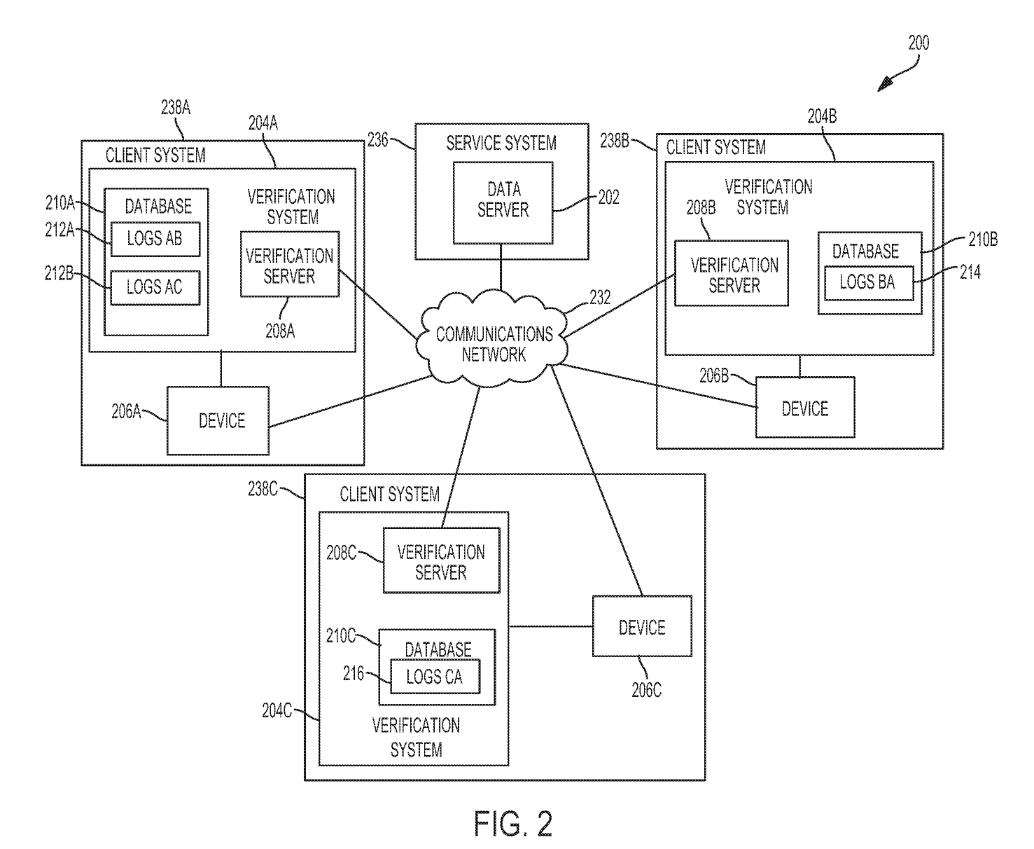

In some embodiments, system 100 includes verification system 104 that implements data verification techniques that are scalable for processing high volumes or frequencies of data records. For example, FIG. 2 shows an example embodiment of system 100 where one or more of client systems 238A-C may each implement portions of or the entirety of verification system 104. When the verification systems 204A-C of two or more client systems 238A-C are configured to cooperatively verify specific types of data, system 200 as a whole may process higher volumes of data records faster and in a more secure manner. Additionally, the verification systems 204A-C of two or more client systems 238A-C may independently store copies of the verified data to provide redundancy in data storage.

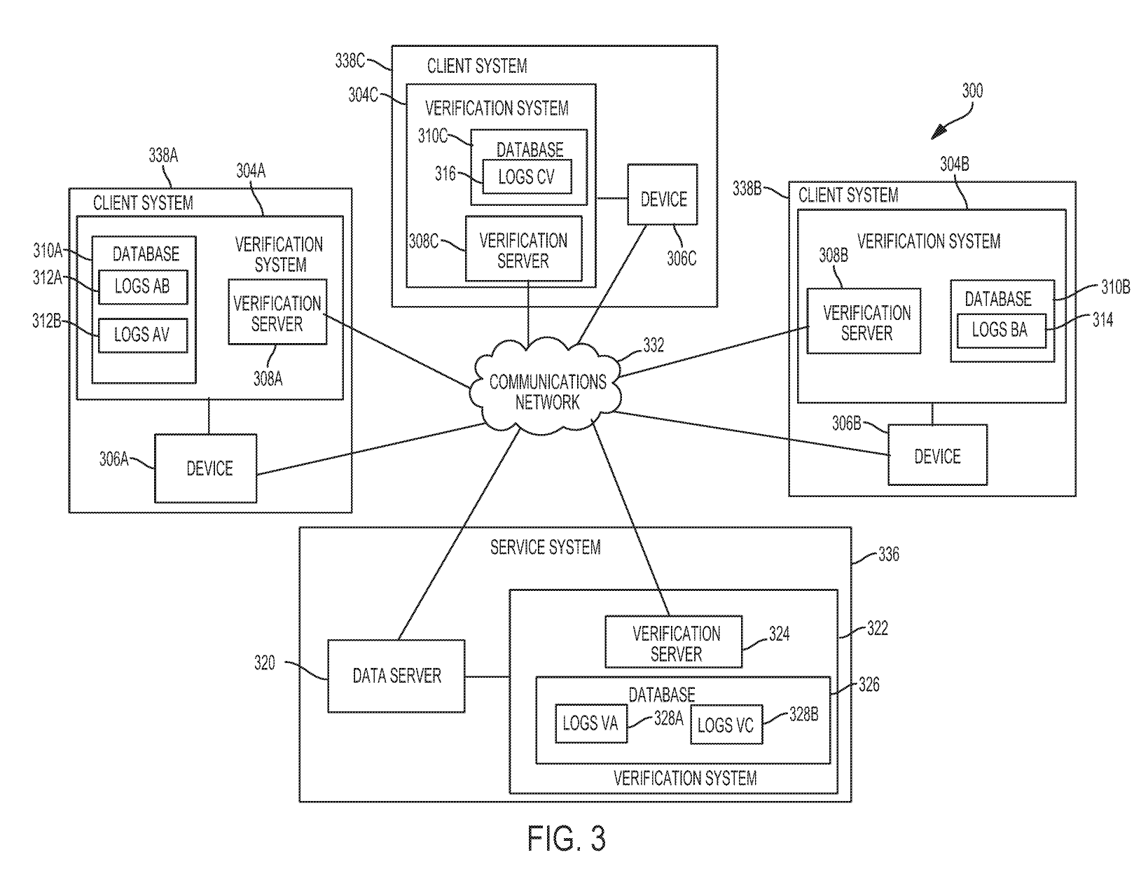

In some embodiments, verification system 104 may be directly coupled to or implemented within service system 106 to enable scalable data verification and data storage redundancy. In these embodiments, one or more client systems 108A-C may be accessing data generated by service system 106. For example, FIG. 3 shows an example embodiment of system 100 where verification system 322 is implemented within a service system 336. One or more of client systems 338A-C may be accessing data generated by or stored by data server 320 of service system 336.

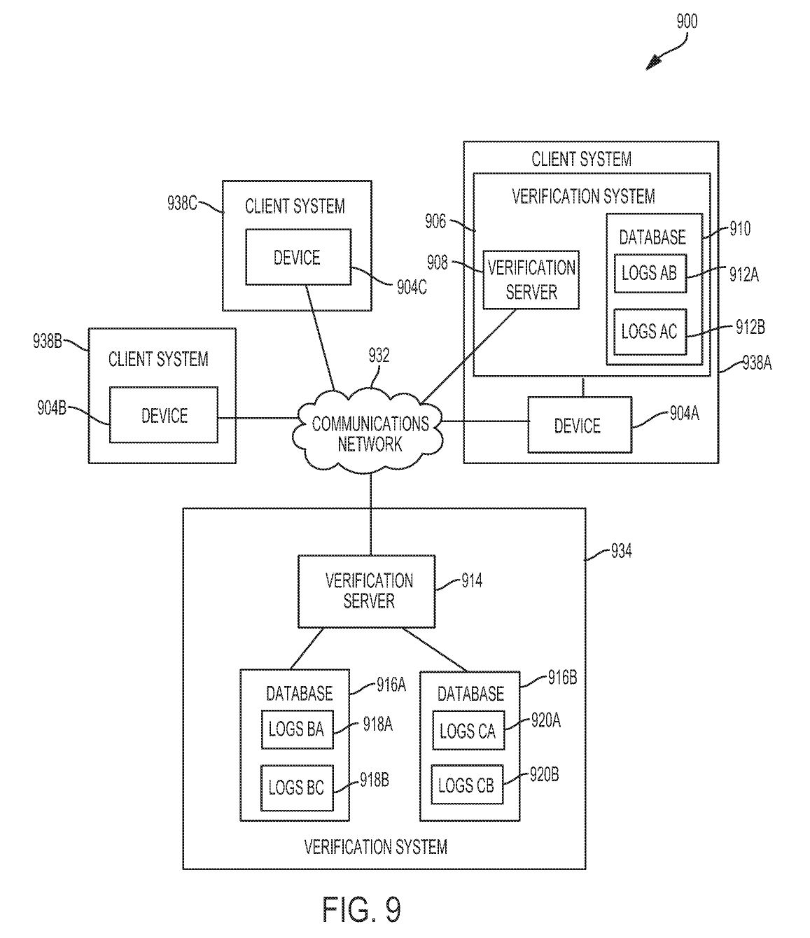

In some embodiments, verification system 104 may be a system that verifies and stores data associated with two or more of client systems 108A-C operating separately from the verification system. For example, FIG. 9 shows an example embodiment of system 100 where verification system 934 may be a separate system, e.g., a cloud system, that verifies data of two or more of client systems 938A-C. In some embodiments, when, for example, two or more client systems 108A-B each offload data verification and storage functionality to verification system 934, data exchanged or associated with the two or more client systems 938A-B may be processed at higher speeds and more securely.

FIG. 2 illustrates a system 200 including one or more client systems 238A-C that each may implement a respective verification system 204A-C to facilitate scalable data verification and redundant, immutable storage of verified data, according to some embodiments. System 200 may represent an example implementation of system 100 from FIG. 1. Like the similarly-named components described with respect to FIG. 1, system 200 includes client systems 238A-C coupled to each other and service system 236 via communications network 232.

In some embodiments, service system 236 includes data server 202 for storing data associated with two or more client systems 238A-C. The data may be received from one of client systems 238A-C, e.g., from one of devices 206A-C, or from a third party system. For example, data server 202 may receive a PDF file from client system 238A where the data includes content associated with client systems 238A and 238B. In some embodiments, data server 202 may send the data to one or more client systems associated with the data. For example, the PDF file referenced above may be sent from data server 202 to client system 238B that cooperatively verifies the data with client system 238A.

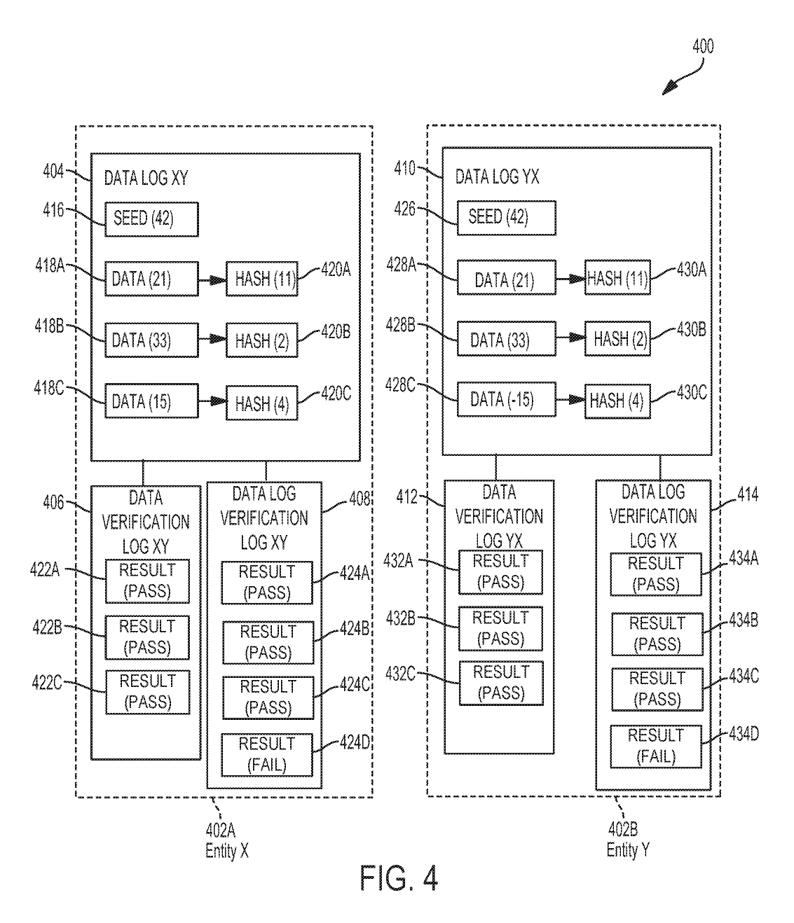

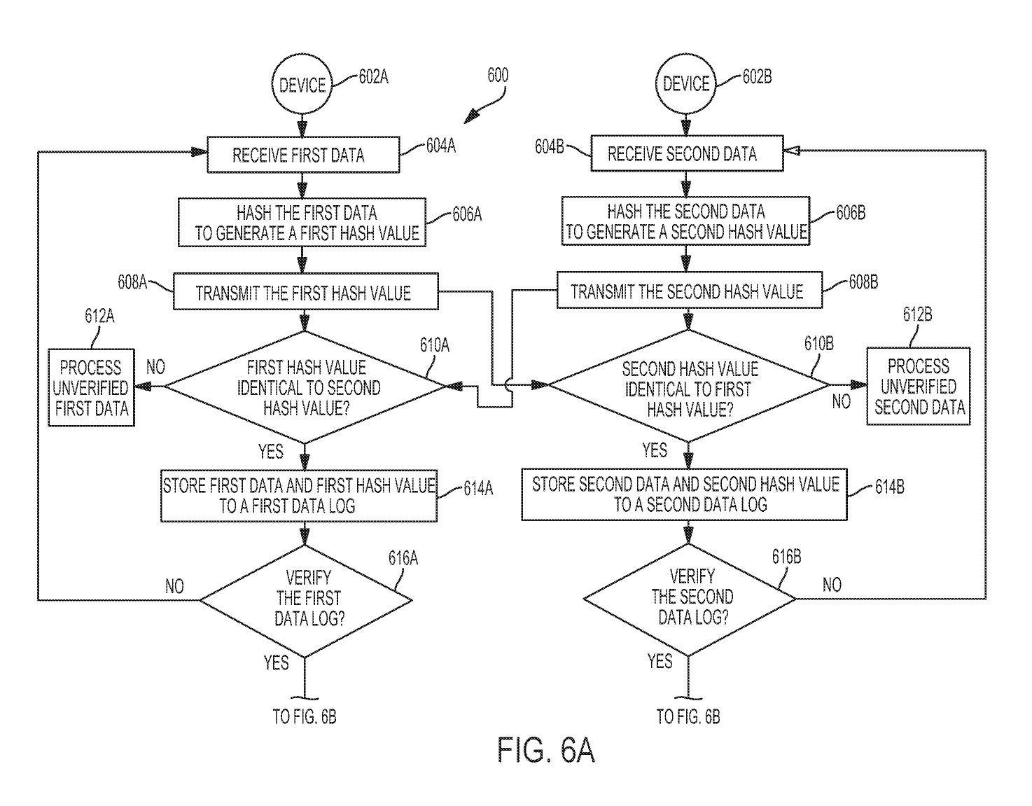

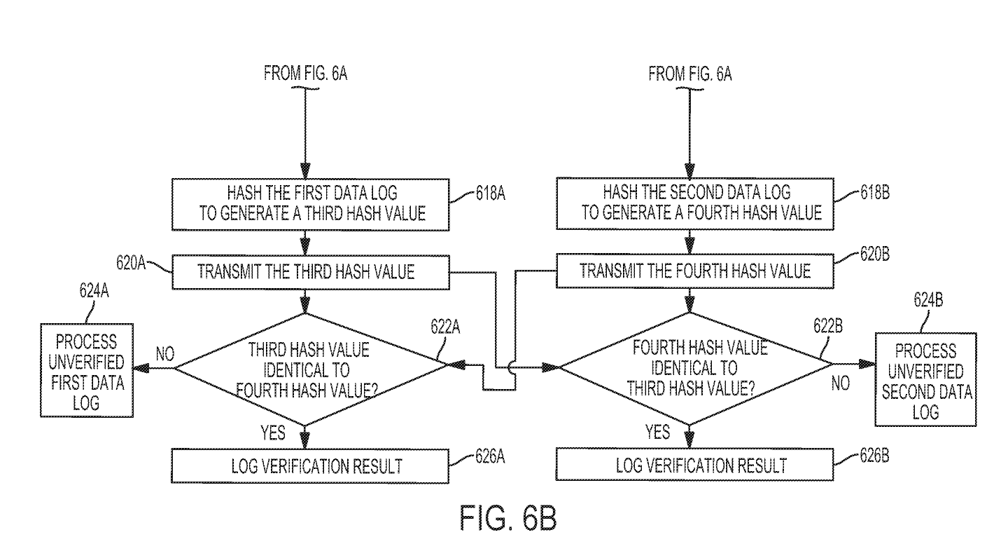

In some embodiments, one or more of client systems 238A-C may implement portions of or the entirety of verification system 104 of FIG. 1. As shown, for example, client systems 238A-C include verification systems 204A-C, respectively. Each of verification system 204A-C may implement respective verification servers 208A-C coupled to respective databases 210A-C for storing respective logs 212A-B, 214, and 216. In some embodiments, databases 210A-C store data that has been cooperatively verified by two or more client systems 238A-C. In some embodiments, each of verification servers 208A-C may include one or more processors coupled to computer-readable media storing computer instructions that, when executed, cause respective verification servers 208A-C to execute or enable the methods and mechanisms disclosed herein. For example, methods and mechanisms related to cooperative data verification are described with respect to FIGS. 4, 6A-B, and 8.

In some embodiments and in contrast to traditional blockchain implementations where each node maintains a copy of the entire distributed database, one or more of client systems 238A-C may be configured to verify and subsequently store only those data records associated with itself. For example, a data record may be associated with client systems 238A and 238B. In this example, only client systems 238A and 238B may receive the data record to be verified and stored. No other client systems, e.g., client system 238C, will participate in the verification and storage of the data record.

As described above, the data record may be received from service system 236 or generated by one of devices 206A-C. In some embodiments, a device, e.g., one of devices 206A-C, implements a user interfaces that allows a user to input information used by the device to generate a data record associated with two or more client systems 238A-C. Then, to facilitate scalable and secure data verification, system 200 may be configured such that only the two or more client systems 238A-C associated with the data record cooperatively verify the data record and independently store the data record upon cooperative verification. Further, in some embodiments, the two or more client systems 238A-C independently storing verified data may periodically, on-demand, algorithmically, or randomly engage in cooperative verification of stored data. This cooperative verification of stored data may safeguard the redundantly-stored data from corruption or unauthorized modifications. Embodiments for cooperatively verifying stored data are described with respect to FIGS. 4, 6A-B, and 7-8.

In the example embodiment shown in system 200, client system 238A may implement verification system 204A that stores data records that have been verified in logs 212A-B. In particular, verification server 208A is configured to generate and maintain separate logs 212A-B for each pair of unique entities associated with a received data record. In some embodiments where verification server 208A only receives data records associated with client system 238A, one of the entities in each pair of unique entities includes client system 238A. As an example, verification server 208A may store verified data associated with client systems 238A and 238B in logs 212A (logs AB) and store verified data associated with client systems 238A and 238C in logs 212B (logs AC). Similarly, client system 238B may implement verification system 204B that stores verified data associated with a pair of unique client systems 238B and 238A in logs 214 (logs BA). As shown in system 200, client system 238B will not generate or maintain logs associated with client system 238C if client system 238B has not received a data record associated with client system 238C. Client system 238C may be configured in a similar manner where verification server 208C generates logs 216 (logs CA) for storing verified data associated with client systems 238C and 238A. As shown in system 200, client system 238C will not generate logs associated with client system 238B if client system 238C has not received a data record associated with client system 238B.

In some embodiments, by restricting the types of data verified and stored by each of client systems 238A-C, each of client systems 238A-C may process a higher volume of data records. Therefore, in contrast to current blockchain implementations where each verification system, e.g., a node, in a network is required to store a copy of the entire distributed database, client systems 238A-C may each store a portion (but not the entirety) of the distributed database.

FIG. 3 illustrates a system 300 including a service system 336 that implements a verification system 322 to facilitate scalable data verification and redundant, immutable storage of verified data, according to some embodiments. System 300 may represent an example implementation of system 100 from FIG. 1. Like the similarly-named components described with respect to FIG. 1, system 300 includes client systems 338A-C and service system 336 coupled to communications network 332.

Like client systems 238A-C described with respect to FIG. 2, in some embodiments, one or more of client systems 338A-C may implement portions of (or the entirety of) verification system 104 described with respect to FIG. 1. For example, client systems 338A-C may include respective verification systems 304A-C that are configured to perform functionality similar to that of verification systems 204A-C described with respect to FIG. 2. In particular, each of verification systems 304A-C may include a respective verification server 308A-C coupled to a respective database 310A-C for storing respective logs 312A-B, 314, and 316. Like logs 212A described with respect to FIG. 2, logs 312A (logs AB) generated by verification server 308A store verified data associated with a unique pair of entities, e.g., client systems 338A and 338B. As part of coordinating data verification between client systems 338A and 338B, verification server 308B may generate logs 314 (logs BA) corresponding to logs 312A (logs AB) where both logs 314 and 312A are each associated with client systems 338A and 338B.

In some embodiments, service system 336 includes a data server 320 that operates similarly to data server 202 for generating data, e.g., a data record, associated with one or more client systems 338A-C based on input from one or more client systems 338A-C. In some embodiments, data server 320 generates data, e.g., a data record, associated with two client systems e.g., client system 338A and 338B, based on input from one or both of the client systems. Further, service system 336 may implement a verification system 322 to partake in cooperative data verification with one or more of client systems 338A-C, according to some embodiments.

Similar to client systems 338A-C, service system 336 may implement verification system 322 that includes a verification server 324 coupled to a database 326 for storing logs 328A-B associated with service system 336. Verification server 324 may include one or more processors coupled to computer-readable media storing computer instructions that, when executed, cause verification server 324 to execute or enable the methods and mechanisms disclosed herein. In some embodiments, data generated by data server 320 based on a request from a client system may be cooperatively verified by verification server 320 and the client system that originated that request. Upon cooperatively verifying the generated data, verification server 320 may store the verified data in respective logs 328A-B that correspond to the client system that originated the request. For example, verification server 324 may receive a request from device 306A associated with client system 338A. Upon cooperatively verifying the generated data with client system 338A, verification server 324 may store the verified data in logs 328A (logs VA) corresponding to the unique pair of entities: client system 338A and service system 336. Similarly, database 326 includes logs 328B (logs VC) for storing verified data associated with requests generated by, e.g., device 306B of client system 338B. As shown, database 326 does not generate logs associated with client system 338B because service system 336 may not have received a request from client system 338B to generate data to be verified and stored.

In some embodiments, as part of cooperatively verifying data, the participating verification systems each independently store verified data. For example, as shown, service system 336 and client system 338A may cooperatively verify data associated with client system 338A and service system 336. Upon successful verification, service system 336 and client system 338A may each store a copy of the verified data in respective logs 328A (logs VA) and logs 312B (logs AV). Similarly, service system 336 and client system 338C may cooperatively verify data associated with service system 336 and client system 338C. Upon successful verification, service system 336 and client system 338C may store a copy of the verified data in respective logs 328B (logs VC) and logs 316 (logs CV).

In some embodiments, to ensure that the verified data stored redundantly in, e.g., logs 312B and 328A are not modified without authorization, client system 338A and service system 336 may periodically, on-demand, algorithmically, or randomly verify that logs 312B and 328A match. Embodiments for when and how often the redundant logs are verified are further described with respect to FIGS. 4, 6A-B, and 7-8.

FIG. 9 illustrates a system 900 including a verification system 934 that verifies and stores data, e.g., a data record, associated with two or more client systems, e.g., two or more of client systems 938A-C, operating separately from verification system 934, according to some embodiments. System 900 may represent an example implementation of system 100 from FIG. 1. Like the similarly-named components described with respect to FIG. 1, system 900 includes client systems 938A-C and service system 936 coupled to communications network 932.

In some embodiments, client system 938A may operate similarly to client system 238A described with respect to FIG. 2. In particular, like client system 238A, client system 938A may implement a verification system 906 that includes a verification server 908 coupled to a database 910 for storing logs 912A-B. Verification server 908 may include one or more processors coupled to computer-readable media storing computer instructions that, when executed, cause verification server 908 to execute or enable the methods disclosed herein.

In some embodiments, verification server 908 generates separate logs 912A-B to store verified data records associated with unique pairs of entities. For example, logs 912A (logs AB) may store verified data associated with client systems 938A and 938B. Similarly, logs 912B (logs AC) may store verified data associated with a different unique pair of entities, e.g., client systems 938A and 938C. In some embodiments and like device 206A described with respect to FIG. 2, device 904A may generate the data records to be verified and stored in logs 912A-B. In some embodiments, device 904A may implement a user interface to allow a user to submit input to a service system, such as service system 106 of FIG. 1, that generates the data record to be verified and stored in logs 912A-B.

In some embodiments and in contrast to client systems 238B-C from FIG. 2, client systems 938B-C may not necessarily implement respective verification systems. Instead, each of client systems 238B-C may “outsource” the data verification and storage processing to a separate system or device. In some embodiments, two or more client systems 938B-C may each “outsource” to the same system that implements a verification system 934. In some embodiments, by offloading the resource-intensive data verification and storage processing to verification system 934, each of client systems 938B-C may not need to implement expensive and complex hardware architectures nor maintain and update such complex hardware architectures.

In some embodiments, verification system 934 includes one or more computing devices to implement a verification server 914 coupled to databases 916A-B. Verification system 934 may be an example embodiment of verification system 104 described with respect to FIG. 1. Verification server 914 may include one or more processors coupled to computer-readable media storing computer instructions that, when executed, cause verification server 914 to execute or enable the methods disclosed herein.

In some embodiments, verification system 934 is implemented as part of a “cloud” where a network of remote servers hosted on the internet or on a private network provides shared computer processing resources (e.g., computer networks, servers, data storage, applications, and services) to a plurality of users, such as the users of two or more client systems 938B-C. For example, verification system 934 may be provisioned within a cloud computing service such as Amazon Web Services (AWS), IBM SmartCloud, Microsoft Azure, Google Cloud Platform, etc.

In some embodiments, verification system 934 performs similar functionality as verification system 906 implemented by or within client system 938A. For example, verification system 934 may communicate with devices 904B-C from client systems 938B-C, respectively, to verify data and store verified data securely and immutably. In some embodiments, verification system 934 may receive data to be verified from a service system such as service system 106 described with respect to FIG. 1. In some embodiments, verification server 914 may store verified data associated with client systems 938A-B in respective, logically separate databases 916A-B. For example, database 916A-B may be logically partitioned within a single database. In another example, databases 916A-B may be separate databases.

In an example embodiment, verification server 914 may receive data, e.g., a data record, from client system 938B (e.g., device 904B), client system 938A (e.g., verification server 908 or device 904A), or a service system (e.g., service system 106 (not shown)). The data record may include content indicating client systems 938A and 938B. Before storing the data, verification server 914 may engage in cooperative verification with verification system 906 of client system 938A to verify the received data, as described with respect to FIGS. 4, 6A-B, and 7-8. Upon verifying the received data, verification server 914 may store the verified data in logs 918A (logs BA) storing data associated with client systems 938B and 938A. Similarly, verification system 906 of client system 938A independently and redundantly stores the cooperatively verified data in its logs 912A (logs AB). In some embodiments, to ensure that the verified data has been properly stored in logs 918A and 912A, verification servers 914 and 908 may engage in cooperative verification of stored data, as described with respect to FIGS. 4, 6A-B, and 7-8. If the verified data has been stored without unauthorized modifications or data corruption, then logs 918A should be identical to logs 912A. Further, in some embodiments, to ensure that logs 918A and 912A remain immutable, verification servers 914 and 908 may periodically, on-demand, algorithmically, or randomly verify that logs 918A and 912A are in concurrence, i.e., store the same contents.

In some embodiments, verification system 934 can process data verification and storage of verified data faster and more securely than verification systems 204A-C respectively implemented in client systems 238A-C of FIG. 2. For example, verification server 914 may receive data, e.g., a data record, associated with client systems 938B and 938C. As discussed above, the data record may be received from client system 938B, client system 938C, or a service system (e.g., service system 106 of FIG. 1). In this example, verification system 934 may not need to cooperatively verify the data with another system before storing the data as verified data because verification server 914 implements the data verification and storage functionalities of both client systems 938B and 938C associated with the received data.

In some embodiments, upon verifying the data, verification server 914 may store a copy of the data in logs 918B (logs BC) and logs 920B (logs CB). Logs 918B may be stored in database 916A associated with client system 938B. Likewise, logs 920B may be stored in database 916B associated with client system 938C. Because a single verification system 934, e.g., verification server 914, manages the redundant storage of verified data in both logs 918B and 920B, the stored data may be stored more securely and with less delay as no additional information needs to be transmitted over communications network 932.

FIG. 4 is a diagram 400 that illustrates logs 404-414 maintained for entity 402A “entity X” and entity 402B “entity Y”, according to some embodiments. In some embodiments, entity 402A may be associated with client system 108A from FIG. 1 and entity 402B may be associated with another system such as client system 108B, client system 108C, or service system 106 from FIG. 1. In some embodiments, entities 402A and 402B may be respectively associated with client systems 238A and 238B from FIG. 2. In some embodiments, entities 402A and 402B may be respectively associated with client system 338A and service system 336 from FIG. 3. In some embodiments, entities 402A and 402B may be respectively associated with client systems 938B and 938C from FIG. 9. In some embodiments, entities 402A and 402B may be respectively associated with client systems 938A and 938B.

For ease of understanding how data associated with entities 402A and 402B is cooperatively verified and independently stored in an immutable manner, operations associated with logs 404-408 will be described with respect to a first device and operations associated with logs 410-414 will be described with respect to a second device. In some embodiments, for example as shown in FIG. 2, the first and second devices may be two of verification servers 208A-C independently implemented by corresponding client systems 238A-C. In some embodiments, for example as shown in FIG. 3, one of the first and second devices may be a verification server 324 implemented by service system 336 and the other device may be a verification server, e.g., one of verification servers 308A-C, implemented within a client system, e.g., one of client systems 308A-C. In some embodiments, for example as shown in FIG. 9, the first and second devices may refer to a single verification server, e.g., verification server 914, within a verification system 934.

In some embodiments, as described with respect to FIGS. 2, 3, and 9, each of the first and second devices generates separate logs associated with each unique pair of entities. For example, the first device generates data log “XY” 404 for storing verified data 418A-C associated with entities 402A and 402B. Similarly, the second device generates data log “YX” 410 for storing verified data 428A-C associated with entities 402A and 402B.

In some embodiments, the first device initializes data log 404 by storing a seed 416. Seed 416 may be a sequence of bits (e.g., representing a file, a data record, a number, etc.) received at the first device. In some embodiments, the first device receives seed 416, e.g., a value of 42, from a user associated with entity 402A or 402B. In some embodiments, the first device receives seed 416 from the second device associated with entity 402B. In some embodiments, the first device hashes another data log associated with entities 402A and 402B to generate seed 416. In some embodiments, to reduce the vulnerability of data log 404 to unauthorized modifications, the first device may select a cryptographic hash algorithm with specific properties to generate seed 416.

With respect to entity 402B, the second device may similarly initialize data log 408 with seed 426. In some embodiments, the first and second devices transmit seeds 416 and 426, respectively, to each other to verify that seeds 416 and 426 match. In some embodiments, instead of transmitting the seeds directly, the devices may exchange hashes of respective data logs storing the respective seeds. For example, the first device may transmit to the second device a hash value generated by hashing data log 404 storing seed 416. Similarly, the first and second devices may verify that seeds 416 and 426 match by comparing the corresponding hash values.

In general a cryptographic hash algorithm is a hash function that converts an input, e.g., a message or a file, into an output hash value with a fixed size, e.g., a four byte value. In some embodiments, the first device uses a cryptographic hash algorithm that has the two properties: it is extremely computationally difficult to generate the input that results in a specific hash value using the cryptographic hash algorithm; and it is extremely unlikely that any two slightly different inputs to the cryptographic hash algorithm will result in the same hash value. In some embodiments, the cryptographic hash algorithm exhibits an additional property known as the Avalanche effect where a small change to the input, e.g., a single bit is complemented, leads to large changes in the output, e.g., many of the output bits are complemented. For example, the cryptographic hash function may satisfy the Strict Avalanche Criterion (SAC) where if, whenever a single input bit is complemented, each of the outputs bits should be complemented with a probability of one half.

In some embodiments, the first and second devices cooperatively verify data, e.g., a data record, associated with entities 402A and 402B. For example, each of the first and second devices may receive data represented by a value of “21.” In some embodiments, each of the first and second devices independently generates a hash value of the data respectively received. For example, the first and second devices may both generate a hash value of “11.” Then, each device transmits the generated hash value to the other device to be compared against a locally-generated hash value. In some embodiments, upon determining that the hash value of “11” generated by the first device matches the hash value of “11” received from the second device, the first device stores in data log 404 the received data and generated hash value as data 418A and hash 420A, respectively. The second device may perform similar operations and store the same data and hash value as data 428A and hash 430A, respectively, in data log 410.

In some embodiments, as part of cooperatively verifying data, the first and second devices may generate and transmit respective digital signatures to allow a device receiving data to authenticate the device sending the data and validate contents in the received data. In some embodiments, a first device may generate a digital signature associated with the received data and transmit the digital signature along with a hash of the received data to the second device. To generate the digital signature, the first device may encrypt the hash of the received data (e.g., the hash value of “11”) with a private key associated with the first device. The generated digital signature may include the encrypted hash and, in some embodiments, a public key associated with the private key. By sending the digital signature, the first device enables the second device to authenticate data as being sent from the first device. Likewise, the second device may similarly generate and transmit a digital signature to the first device to enable the first device to authenticate received data as being received from the second device.

For example, in addition to receiving the hash value of “11” from the first device, the second device may receive a digital signature generated by the first device and associated with the received hash value of “11.” Then, the second device may decrypt the encrypted hash stored in the digital signature. In some embodiments, the second device may decrypt the encrypted hash using a public key stored locally on the second device. In some embodiments, the second device receives the public key from the digital signature. Because the encrypted hash should be generated from a private key associated with the public key, the second device can authenticate data as being received from the first device if the decrypted result matches the hash value received from the first device.

In some embodiments, due to the use of a cryptographic hash algorithm with the specific properties discussed above, it is extremely unlikely that two different data inputs (even with only a slight difference) will result in the same hash value. Therefore, the first device's confirmation that the received hash value is the same as its generated hash value indicates, with a very high probability, that the second device received the same data and used the same cryptographic hash algorithm. In this manner, the first device may populate data log 404 with verified data 418A-C and corresponding hashes 420A-C. Similarly, the second device may populate data log 410 with verified data 428A-C and corresponding hashes 430A-C.

In some embodiments, the first device generates one or more verification logs (e.g., data verification log 406 and data log verification log 408) corresponding to data log 404. In some embodiments, the first device may generate a single data verification log including the verification results stored in both data verification log 406 and data log verification log 408. The second device may similarly generate one or more verification logs (e.g., data verification log 412 and data log verification log 414) corresponding to data log 410. In some embodiment, the verification result of each piece of data, e.g., a data record, received by the first device is stored as a respective result 422A-C in data verification log 406. In some embodiments, a verification result (e.g., each of results 422A-C) may include whether verification passed or failed along with associated metadata. For example, metadata stored in results 422A-C may include a generated hash value, a timestamp, a received hash value, information identifying a source of the received hash value, information identifying the cryptographic hash algorithm used to generate the hash value, a digital signature received with the hash value, or a combination thereof. As shown, the first and second devices may have cooperatively verified the data corresponding to stored data 418A-C and 428A-C. Accordingly, the first device stores “PASS” verification results 422A-C for data corresponding to stored data 418A-C and the second device stores “PASS” verification results 432A-C for data corresponding to stored data 428A-C.

As shown in FIG. 4, in some embodiments, though data associated with entities 402A and 402B may be cooperatively verified, the verified data may not have been identically stored in one or both of data logs 404 and 410. For example, the first and second devices may have each received data corresponding to a value of 15 and verified the data by comparing independently generated hash values of 4. But, whereas the first device stores the data as data 418C with a value of 15, the second device may have stored the data as data 428C with a value of −15. In some embodiments, to ensure that verified data is independently and identically stored to data logs 404 and 410, each of the first and second devices may engage in cooperative verification of data logs 404 and 410.

In some embodiments, to cooperatively verify data logs 404 and 410, each of the first and second devices may hash the data logs 404 and 410 to generate respective hash values. Then, similar to cooperatively verifying data, the first and second devices may exchange generated hash values and determine whether the hash values generated by the first and second devices are identical. In some embodiments, the first and second devices select a cryptographic hash algorithm with the above-described properties to hash the data logs 404 and 410 such that any small difference between data logs 404 and 410 will result in vastly different hash values.

In some embodiments, the first and second devices stores the verification results of comparing the hashes of data logs 404 and 410 to respective data log verification logs 408 and 414. The verification results are stored as results 424A-D and 434A-D in respective data log verification logs 408 and 414. In some embodiments, the stored verification results may include whether verification passed or failed along with associated metadata. For example, metadata stored in results 424A-D and 434A-D may include a generated hash value, a timestamp, a received hash value, information identifying a source of the received hash value, information identifying the cryptographic hash algorithm used to generate the hash value, a digital signature received with the hash value, or a combination thereof.

In some embodiments, the first and second devices cooperatively verify data logs 404 and 410 after every entry to data logs 404 and 410. For example, upon initializing data log 404 with seed 416, the first device initiates cooperative verification of data log 404 with the second device to generate result 424A. As the second device stores seed 426 with the same value of 42, the hash values exchanged by the first and second values will be the same and the first and second device stores a “PASS” verification result 424A and 432A in respective data log verification logs 408 and 414.

Similarly, upon storing data 418A of value 21 and associated hash 420A of value 11, the first device may initiate cooperative verification of data log 404 with the second device to generate result 424B. Result 424B indicates a “PASS” because, as seen in data log 410, the second device stored data 428A and hash 430A with identical values. In contrast, however, the first device may generate and store a “FAIL” result 424D when cooperatively verifying data log 404 storing data 418C of value “15” because the second device stored data 428C of value “−15” in data log 410. Similarly, the second device may generate a “FAIL” result 434D because the contents of data logs 404 and 410 are not identical. In some embodiments, as described above, whether data logs 404 and 410 match is determined by hashing the data logs 404 and 410 using a cryptographic hash function and comparing the generated hash values.

In some embodiments, if verification failed, the first and second devices may engage in a reconciliation process. For example, the first device that generated the “FAIL” result 424D may retransmit the hash of data log 404 to the second device. In another example, the first device that generated the “FAIL” result 424D may rehash data log 404 and transmit to the second device the re-generated hash value. In some embodiments, the first device that generated the “FAIL” result 424D may alert an administrator of entity 402A of the failed verification because this result may indicate a presence of a security breach or a presence of critical errors in the hardware performing the verification.

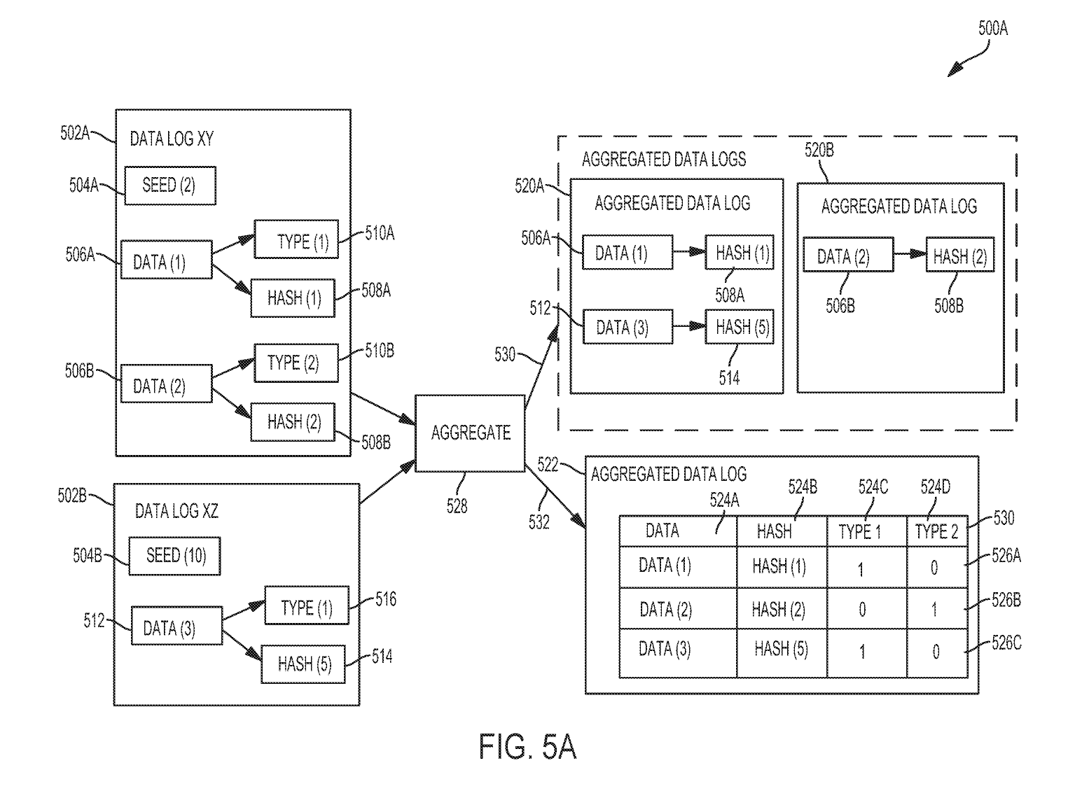

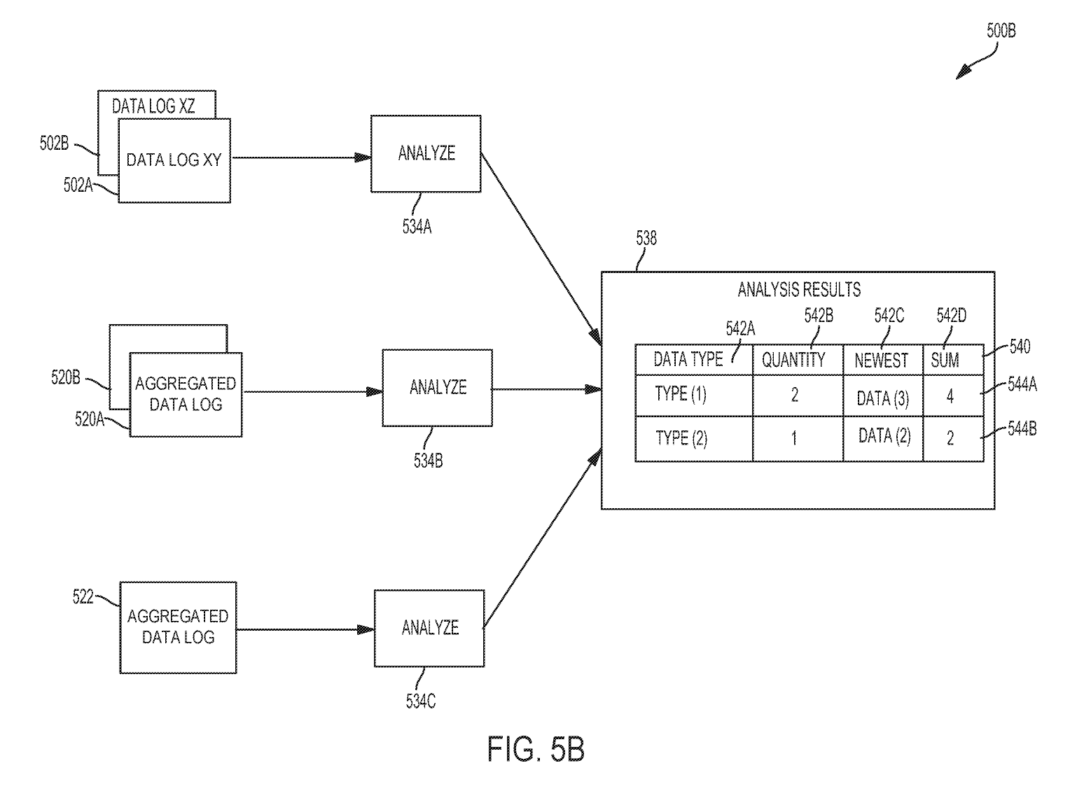

FIG. 5A is a diagram 500A that illustrates how data logs 502A-B may be aggregated, according to some embodiments. In some embodiments, the aggregation mechanism described with respect to diagram 500A is performed by a verification server described with respect to any of FIGS. 1-3 and 9. In some embodiments, the aggregation mechanism described with respect to diagram 500A is performed by a device associated with entity 402A as described with respect to FIG. 4.

As shown in diagram 500A, a verification server generates and updates data logs 502A-B. In some embodiments, the verification server generates a data log for each unique pair of entities. For example, data log 502A may be generated and configured to store data associated with entities X and Y. And data log 502B may be generated and configured to store data associated with entities X and Z. In some embodiments, the verification server stores only data that has been verified in data logs 502A-B.

In some embodiments, as described with respect to FIG. 4, the verification server initializes each data log with a seed and stores verified data with corresponding hash values. For example, the verification server may store seed 504A with value “2” in data log 502A and store data records 506A-B with respective hashes 508A-B. In some embodiments, the verification server associates data 506 with a type of data 510. For example, data 506A that is received by the verification server may be received with a tag indicating a data type of “1,” stored as type 510A in data log 502A. In an example, the verification server determines the type 510A of data 506A based on analyzing contents of data 506A. With respect to data log 502B, the verification server may similarly initialize data log 502B with seed 504B, e.g., with a value of “10,” and store verified data 512 with value of “3” associated with a type 516 of “1” and a hash 514 of “5.”

In some embodiments as shown by arrow 530, the verification server aggregates 528 two or more data logs 502A-B to generate a plurality of aggregated data logs 520A-B. In some embodiments, the verification server generates an aggregated data log for each type of data. For example, the verification server may generate aggregate data log 520A for storing portions of data logs 502A-B associated with a type of “1.” As shown, the verification server stores data 506A (and associated hash 508A) and data 512 (and associated hash 514) from data logs 502A and 502B, respectively. Similarly, the verification server may generate aggregate data log 520B for storing portions of data logs 502A-B associated with a type of “2.” A shown, the verification server stores data 506B and associated hash 508B from data log 502A.

In some embodiments as shown by arrow 532, the verification server aggregates 528 two or more data logs 502A-B to generate an aggregated data log 522 associated with a plurality of data types. For example, the verification server may aggregate data 506A-B and 512 associated with a type of values “1” and “2” within a table data structure 530. A skilled artisan would recognize, however, that other types of data structures may be implemented by the verification server to aggregate data from data logs 502A-B.

In some embodiments, the verification server generates table data structure 530 including fields 524A-D and rows 526A-C. For example, table data structure 530 may include a data field 524A, a hash field 524B, and one or more type fields 524C-D. In some embodiments, for example, the verification server generates a number of type fields 524C-D that matches the number of different types of data detected across data logs 502A-B.

As shown, rows 526A-C may correspond to each piece of verified data 506A-B and 512 from data logs 502A-B. For example, the verification server stores data 506A and associated hash 508A in row 526A. Further, the verification server may indicate in row 526A that data 506A is associated with a type of “1” and not a type of “2.” Similarly, for data 506B stored in row 526B, the verification server may indicate in row 526B that data 506B is associated with a type of “2.”

FIG. 5B is a diagram 500B illustrating example analysis performed on verified data, according to some embodiments. In some embodiments, the analysis 534A-C described with respect to diagram 500B is performed by the verification server described with respect to FIG. 5A. In some embodiments, the verification server analyzes 534A-C verified data to generate statistics of verified data from a plurality of data logs 502A-B. In some embodiments, the verification server may directly analyze 534A data logs 502A-B to generate analysis results 538 storing generated statistics. In some embodiments, the verification server may analyze 538B aggregated data logs 520A-B where each of aggregated data logs 520A-B may store data associated with a specific data type. In some embodiments, the verification server analyzes 534C aggregated data log 522 storing verified data associated with a plurality of data types.

In some embodiments, the verification server formats analysis results 538 in a table data structure 540. By generating analysis results 538, the verification server may enable relevant metadata and various statistics about verified data from multiple data logs 502A-B to be rapidly queried. For example, generated statistics may include counts of data records satisfying one or more criteria, a sum of numerical values in data records satisfying one or more criterion, a mean of numerical values in data records satisfying one or more criterion, etc. Though analysis results 538 have been shown to be formatted within table data structure 540, a skilled artisan would recognize that other types of data structures may be implemented by the verification server.

In some embodiments, the verification server generates table data structure 540 including fields 542A-D and rows 544A-B. For example, table data structure 540 may include a data type field 542A and one or more analysis fields. In some embodiments, the verification server generates a plurality of analysis fields that include metadata related to the different types of data detected across data logs 502A-B. For example, as shown in analysis results 538, these analysis fields may include a quantity field 524B representing a count of data records, a newest field 542C representing the most recent data record, and a sum field 542D representing the sum of values across counted data records. As described above, the verification server may analyze 534A data logs 502A-B directly or analyze 534B-534C aggregated forms of data logs 502A-B.

As an example, upon analyzing data records 506A-B and data record 512 from data logs 502A-B, the verification server may generate rows 544A-B. In row 544A, the verification server may store metadata about data type of value “1”. For example, in row 544A, the verification server may indicate: under quantity field 542 a value of “2” to represent two data records (i.e., two data records 506A and 512) associated with the data type of “1”, a value of “3” under newest field 542C to represent the newest data record of the data type of “1” (i.e., data record 512), and a value of “4” under sum field 542D to represent the sum of the data records of the data type of “1” (i.e., data records 506A and 512). Similarly, for data records of type “21” stored in row 544B, the verification server may indicate in row 544B the quantity of data records with the data type of “2” with a value of “1” representing a single data record 506B, the newest data record of the data type of “2” with a value of “2” representing data record 506B, and the sum of data records of the data type of “2” with a value of “2”. A skilled artisan would recognize, however, that other types of relevant metadata may be calculated by the verification server based on the verified data stored in data logs 502A-B.

FIGS. 6A-B is a method 600 for cooperatively verifying data and facilitating redundant, immutable storage of verified data, according to some embodiments. In some embodiments, data, e.g., a data record, associated with a first and a second entity are cooperatively verified and redundantly stored by devices 602A and 602B. In some embodiments, the first and second entities may correspond to entities 402A and 402B described with respect to FIG. 4. In some embodiments, as was described with respect to FIG. 4, devices 602A and 602B may correspond to client systems 108A and 108B from FIG. 1, respectively. In some embodiments, devices 602A and 602B may correspond to verification systems 238A and 238B from FIG. 2, respectively. In some embodiments, devices 602A and 602B may correspond to verification systems 322 and one of verification systems 304A-C from FIG. 3, respectively. In some embodiments, devices 602A and 602B may both correspond to verification system 934 from FIG. 9.

In step 604A, device 602A receives first data to be verified against second data at device 602B. In some embodiments, the first and second data are each associated with the first and second entities. For example, the first and second data may each include information indicating the first and second entities. In another example, the first and second data may be received with a message that indicates the first and second entities. In some embodiments, the first and second devices are associated with the first and second entities, respectively.

Similar to step 604A, in step 604B, device 602B receives second data associated with the first and second entities. In some embodiments, the first and second data may be received from one of devices 602A-B, independently received by each of devices 602A-B, or received from a separate data source. As described with respect to FIG. 1, the first and second data may be an electronic file adhering to a specific format (e.g., an image file format, a word processing format, a document format based on an EDI standard, etc.).

In some embodiments, the first and second data is generated by one of devices 602A and 602B. For example, the first data may be generated by device 602A. Then, device 602A may send the first data to device 602B that receives the first data as second data. In some embodiments, devices 602A-B may receive one or more requests from each other or from another system. Then, each of devices 602A-B may independently generate the first and second data based on the received requests. In some embodiments, devices 602A and 604B may receive the first and second data, respectively, from a data source such as service system 106 of FIG. 1.

In steps 606-610, devices 602A and 602B cooperatively verify that the first and second data match before performing independent, redundant storage. In particular, in step 606A, device 602A hashes the first data to generate a first hash value. In some embodiments, device 602A is configured to generate the first hash value using a first cryptographic hash algorithm. In step 608A, device 602A transmits the generated first hash value to device 602B.

In some embodiments, device 602A transmits a digital signature along with the first hash value in step 608A. As described with respect to FIG. 4, device 602A may generate the digital signature by encrypting the first hash value based on a private key associated with device 602A. In some embodiments, the digital signature includes the encrypted first hash value. In some embodiments, the digital signature includes the encrypted first hash value and a public key associated with the private key used to encrypt the first hash value. Also as described with respect to FIG. 4, the public key may enable device 602B to decrypt the digital signature transmitted by device 602A. By decrypting the digital signature, device 602B may verify that the hash value purportedly received from device 602A does in fact originate from device 602A.

Mirroring steps 606A and 608A performed by device 602A, device 602B hashes the second data to generate the second hash value in step 606B and transmits the second hash value to device 602A in step 608B. Likewise, as part of step 606B, the second device may generate and transmit to device 606A a digital signature associated with the second hash value. In some embodiments, to enable devices 602A-B to cooperatively verify the first and second data, both devices 602A-B may be configured to apply the same cryptographic hash function. Therefore, like in step 606A, in step 606B, device 602B hashes the second data received in step 604B using the first cryptographic hash algorithm.

In some embodiments, device 602A selects a cryptographic hash algorithm for hashing the first data based on a type of the first data, content of the first data, a tag received with the first data, an agreement between the entities, or a combination thereof. For example, the first data may be tagged with information indicating the use of a specific cryptographic hash function. Device 602B is configured to select the cryptographic hash algorithm in the same way as device 602A. In some embodiments, by independently hashing the first and second data and exchanging the generated hash values, devices 602A-B can verify that the first and second data received by devices 602A-B, respectively, are identical. Further, by digitally signing the exchanged hash values, devices 602A-B can verify that the hash values transmitted are non-repudiable, authentic, and maintain their integrity.

In step 610A, device 602A determines whether the first hash value generated by hashing the first data matches the second hash value received from device 602B and representing a hash of the second data received in step 604B. Likewise, in step 610B, device 602B determines whether the second hash value generated by hashing the second data matches the first hash value received from device 602A and representing a hash of the first data received in step 604A.

In step 612A, in response to determining that the first and second hash values do not match, device 602A processes the first data as unverified data. In some embodiments, device 602A stores the failed verification as a result in a first data verification log for storing data verification results. In some embodiments, device 602A stops processing the first data upon determining that the first and second hash values do not match. For example, device 602A may not store the first data in the first data log.

In some embodiments, device 602A performs a reconciliation process. For example, device 602A may retransmits to device 602B the first hash value generated in step 606A. In another example, device 602A may re-perform steps 606A and 608A. In another example, device 602A requests device 602B to retransmit the second hash value generated by device 602B or to rehash the second data to regenerate the second hash value. Device 602B may similarly process the second data as unverified data in step 612B if device 602B determines in step 610B that the first and second hash values do not match.

In step 614A, in response to determining that the first and second hash values match, device 602A stores the first data and the first hash value to a first data log associated with the first and second entities. For example, device 602A may append the first data and the first hash value to the first data log. In some embodiments, device 602A generates a data log for every unique pair of entities. In these embodiments, the first data log may be associated with only the first and second entities. Similarly, in step 614B, device 602B stores the second data and the second hash value in a second data log associated with the first and second entities.

In some embodiments, as part of step 614A, device 602A updates the data verification log to indicate that the first data was successively verified. Device 602A may store the verification result with associated metadata, e.g., a timestamp. In some embodiments, the data verification log is associated with the first data log. Similarly, in step 614B, device 602B may update a second data verification log to store a result of verifying the second data.

In step 616A, device 602A determines whether to verify the first data log as being in concurrence with the second data log. In some embodiments, by verifying that the first and second data logs are in concurrence, device 602A ensures that verified data stored in the first data log is stored redundantly and immutably. This is because if any portion of data in the first data log is modified, then the first and second data logs will not be in concurrence. Similarly, in step 616B, device 602B determines whether to verify the second data log as being in concurrence with the first data log.

In some embodiments, device 602A determines whether to verify the first data log based on a request received from device 602B. In some embodiments, device 602A transmits to device 602B a request to verify that the second data log is in concurrence with the first data log. In some embodiments, device 602A transmits the request based on a passage of a predetermined period of time. For example, the predetermined period of time may be every minute, day, week, etc. In some embodiments, device 602A transmits the request based on a receipt of a request to verify the first data log. For example, device 602A may receive the request from a user via a user interface implemented by device 602A. In some embodiments, device 602A transmits the request based on a predetermined number of occurrences of previously-verified data. For example, as described with respect to FIG. 4, device 602A may verify the first data log every time data, e.g., a data record, is verified. In some embodiments, device 602A transmits the request based on a size of the first data log reaching a predetermined data size. In some embodiments, device 602A transmits the request based on a length of time to perform step 618A in a previous iteration. For example, device 602A may transmit the request if the length of time reaches a predetermined threshold.

In some embodiments, device 602A determines whether to verify the first data log based on any combination of the following factors: a passage of a predetermined period of time, a receipt of a request to verify the first data log, a predetermined number of occurrences of previously-verified data, a size of the first data log reaching a predetermined data, or a length of time to hash the first data log. Examples of each of these possible factors are described above.

In steps 618-622, devices 602A and 602B cooperatively verify that the first and second data logs are in concurrence to ensure redundant and immutable storage of verified data. In step 618A, upon determining to verify the first data log in step 616A, device 602A hashes the first data log to generate a third hash value. In some embodiments, device 602A is configured to generate the third hash value using a second cryptographic hash algorithm. For example, the second cryptographic hash algorithm may be the same as the first cryptographic hash algorithm used to generate the first hash value. In step 620A, device 602A transmits the generated third hash value to device 602B. In some embodiments, similar to step 608A, device 602A digitally signs and transmits the generated hash third hash value to device 602B. For example, device 602A may encrypt the third hash value with a private key associated with device 602A. Then, device 602A may include within the digital signature the encrypted third hash value or both the encrypted third hash value and a public key associated with the private key used to encrypt the third hash value.

Mirroring steps 618A and 620A performed by device 602A, device 602B hashes the second data log to generate a fourth hash value in step 618B and transmits the fourth hash value to device 602A in step 620B. In some embodiments and similar to step 608A, device 602B may digitally sign and transmit the fourth hash value to device 602A in step 620B. In some embodiments, to enable devices 602A-B to cooperatively verify the first and second data logs, both devices 602A-B may be configured to apply the same cryptographic hash function. Therefore, like in step 618A, in step 618B, device 602B hashes the second data log using the second cryptographic hash algorithm.

In step 622A, device 602A determines whether the third hash value generated by hashing the first data log matches the fourth hash value received from device 602B device and representing a hash of the second data log. Likewise, in step 622B, device 602B determines whether the fourth hash value generated by hashing the second data matches the third hash value received from device 602A.

In step 624A, in response to determining that the third and fourth hash values do not match, device 602A processes the unverified first data log. In some embodiments, device 602A updates a first data log verification log to indicate that the first and second data logs match, e.g., are identical. For example, device 602A may store the verification result in the first data log verification log. Device 602A may store the verification result with associated metadata, for example a timestamp and a digital signature associated with the hash value.

In some embodiments, device 602A performs a reconciliation process. For example, device 602A may retransmit to device 602B the third hash value generated in step 618A. In another example, device 602A may re-perform steps 618A and 620A. In another example, device 602A requests device 602B to retransmit the fourth hash value generated by device 602B or to rehash the second data log to regenerate the fourth hash value. In some embodiments, in response to determining that the third and fourth hash values do not match, device 602A updates the first data log. For example, device 602A may delete the first data and the first hash value stored to the first data log in 614A. In some embodiments, device 602A restores the first data log to a last-known verified state, i.e., to a state of the first data log that was last verified to match the second data log.

In some embodiments, device 602B may similarly process the second data log as an unverified data log in step 624B if device 602B determines in step 622B that the fourth and third hash values do not match.

In step 626A, in response to determining that the third and fourth hash values match, device 602A updates the data log verification log to indicate that the first and second data logs are verified to be in concurrence. Device 602A may store the verification result with associated metadata, for example a timestamp and a digital signature associated with the hash value.

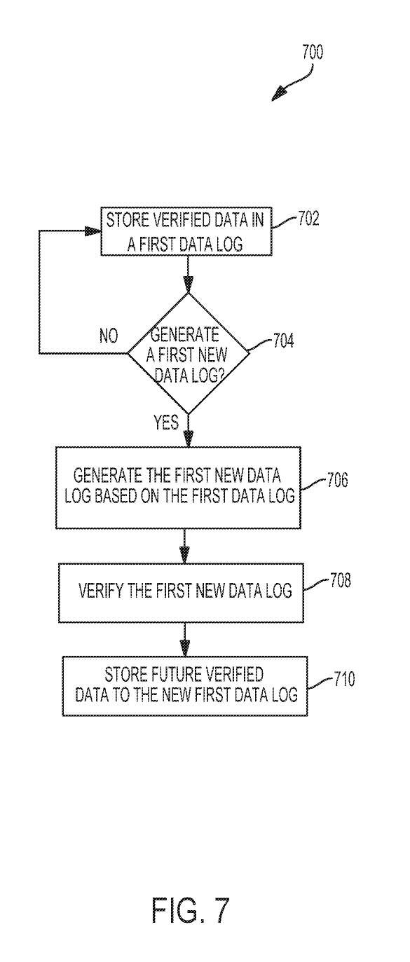

FIG. 7 is a method 700 for generating a new data log for immutable storage of verified data, according to some embodiments. Method 700 may, for example, be implemented by a first device such as one of verification servers 208A-C of FIG. 2, one of verification servers 308A-C of FIG. 3, verification server 324 of FIG. 3, verification server 908 of FIG. 9, or verification server 914 of FIG. 9. In some embodiments, the first device performing method 700 may be device 602A that is in communication with a second device, such as device 602B, as described with respect to FIGS. 6A-B.

In step 702, the first device stores verified data in a first data log. In some embodiments, the first device verifies received data and stores the verified data to the first data log according to steps 604-614 described with respect to device 602A in FIG. 6A.

In step 704, the first device determines whether to generate a new first data log for storing future verified data. In some embodiments, the first device determines whether to generate the new first data log based on any combination of the following factors: a passage of a predetermined period of time, a receipt of a request to generate the new data log, a predetermined number of occurrences of previously-verified data, a size of the first data log reaching a predetermined data, or a length of time to hash the first data log. In some embodiments, to determine whether to generate a new data log, the first device coordinates with a second device that manages a second data log corresponding to the first data log. For example, the first device may receive the request from the second device to generate the new data log. In some embodiments, this coordination causes the second device to generate a new second data log that corresponds to the new first data log to be generated by the first device.

In step 706, in response to determining to generate the new data log, the first device generates the new first data log based on the first data log. In some embodiments, to generate the new first data log, the first device hashes the first data log to generate a seed value. For example, the first device may be configured to use a predetermined cryptographic hash algorithm to generate the seed value. In some embodiments, the first device stores the generated seed value to the new first data log to initialize the new data log. In some embodiments, prior to generating the new first data log, the first device cooperates with the second data to verify that the first data log matches a second data log stored by the second device. For example, the first device may generate a hash of the first data log. Then, the first device may compare the generated hash value with a hash value received from the second device. If the hash values match, then the first device verifies the first data log. In some embodiments, the first device performs steps 618A, 620A, 622A, 624A, and 626A described with respect to FIG. 6.

In step 708, the first device verifies the new first data log of step 706 for storing future verified data. In some embodiments, to verify the new first data log, the first device hashes the new first data log to generate a first hash value. As described with respect to step 706, the new first data log may be initialized to store a seed value. As part of step 708, the first device may receive a second hash value from the second device where the second hash value represents a hash of the new second data log generated by the second device. In some embodiments, the first device verifies the new first data log upon determining that the first hash value and the second hash value match.

In step 710, the first device stores future verified data to the new first data log. In some embodiments, future verified data refers to data that is verified by the first device subsequent to verifying the first new data log in step 708.

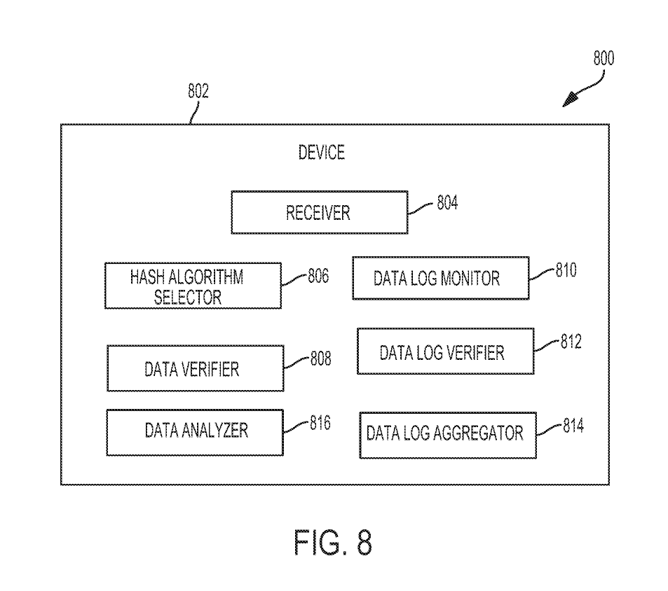

FIG. 8 is a system 800 illustrating components 804-816 of a device 802 for providing scalable data verification, according to some embodiments. In some embodiments, device 802 is an example of a verification server described with respect to FIGS. 1-3 and 9. Each of components 804-816 may include a set of instructions that when executed by one or more processors of device 802 cause the one or more processors to perform that set of instructions. In some embodiments, one or more components 804-816 may perform the mechanisms and steps described with respect to FIGS. 4-7 where device 802 may be a first device in communication with a second device.

In some embodiments, receiver 804 receives inputs or data. For example, receiver 804 may receive first data from a communications network such as communications network 232, 332, 932 described in FIGS. 2, 3, and 9, respectively. In some embodiments, receiver 804 performs step 604A described with respect to FIG. 6.

In some embodiments, data verifier 808 verifies that first data received by receiver 804 matches second data received at a second device. In some embodiments, data verifier 808 coordinates with the second device to verify the received first data. For example, data verifier 808 may hash the received first data according to a predetermined cryptographic hash algorithm to generate a first hash value and transmit the first hash value to the second device. Upon receiving a second hash value from the second device, data verifier 808 may verify the first data if the first and second hash values match. If the first data is verified, data verifier 808 may store the verified data to a first data log storing verified data. For example, data verifier 808 may store results of verifying the first data to a data verification log, such as data verification log 406 described with respect to FIG. 4. In some embodiments, data verifier 808 performs steps 606A, 608A, 610A, 612A, and 614A described with respect to FIG. 6.

In some embodiments, data log verifier 812 determines whether to verify that the first data log storing verified first data matches a second data log storing verified second data at a second device. In some embodiments, data log verifier 812 determines to verify that the first and second logs match based on information monitored by data log monitor 810. In some embodiments, data log verifier 812 coordinates with the second device to verify the first data log. For example, data log verifier 812 may hash the first data log according to a predetermined cryptographic hash algorithm to generate a third hash value and transmit the third hash value to the second device.

Upon receiving a fourth hash value from the second device, data log verifier 812 may verify the first data log if the third and fourth hash values match. If the first data log is verified, data log verifier 812 may update a verification log to indicate that the first data log matches the second data log stored at the second device. For example, data log verifier 812 may store results of verifying the first data log to a data log verification log such as data log verification log 408 described with respect to FIG. 4. In some embodiments, data log verifier 812 performs steps 616A, 618A, 620A, 622A, 624A, and 626A described with respect to FIG. 6.

In some embodiments, data log verifier 812 determines whether to generate a new first data log for storing future verified data. For example, data log verifier 812 may determine to generate the new first data log based on a passage of a predetermined period of time or after receiving a request to generate the new data log from, e.g., the second device. In some embodiments, data log verifier 812 performs method 700 described with respect to FIG. 7 and related to generating a new first data log for storing verified data.

In some embodiments, hash algorithm selector 806 determines which cryptographic hash algorithm that data verifier 808 uses to verify first data. In some embodiments, hash algorithm selector 806 selects a specific cryptographic hash algorithm to verify the first data based on content of the received first data. For example, algorithm selector 806 may select a specific cryptographic hash algorithm based on keyword matching. In some embodiments, hash algorithm selector 806 selects a specific cryptographic hash algorithm to verify the first data based on a tag associated with the first data. For example, the tag may indicate the use of SHA-256, an example cryptographic hash algorithm. In some embodiments, hash algorithm selector 806 selects a cryptographic hash algorithm described with respect to steps 606A.

In some embodiments, hash algorithm selector 806 determines cryptographic hash algorithm that data log verifier 812 uses to verify the first data log. In some embodiments, hash algorithm selector 806 selects a hash algorithm to verify the first data log based on one or more of the following factors: a passage of a predetermined period of time, a receipt of a request to use a specific hashing algorithm, a predetermined number of occurrences of previously-verified data, a size of the first data log reaching a predetermined data size, or any combination thereof. In some embodiments, data log verifier 812 determines the cryptographic hash algorithm to verify the first data log based on information monitored by data log monitor 810. In some embodiments, hash algorithm selector 806 selects a cryptographic hash algorithm described with respect to steps 618A.

In some embodiments, data log monitor 810 monitors information associated with the first data log. For example, data log monitor 810 may monitor a number of occurrences of previously-verified data, a number of occurrences of previously-verified data since the data log was last verified, a data size of the first data log, a timestamp of when the first data log was previously verified, a passage of a period of time since the first data log was last verified, or a combination thereof.

In some embodiments, data log aggregator 814 aggregates data from a plurality of data logs into aggregated data logs. In some embodiments, data log aggregator 814 aggregates one or more portions of each data log into different aggregated data logs based on the type of data in the one or more portions. For example, data log aggregator 814 may generate a plurality of aggregated data logs where each aggregated data log stores data associated with a specific data type. In some embodiments, data log aggregator 814 aggregates data from each data log into a single aggregated data log. In these embodiments, data log aggregator 814 may generate a data structure that indicates data types for aggregated data. In some embodiments, data log aggregator 814 performs the data aggregation mechanism described with respect to FIG. 5A.

In some embodiments, data analyzer 816 analyzes data verified by data verifier 808 to generate analysis results. For example, data analyzer 816 may analyze the one or more data logs of verified data generated and verified by data log verifier 812. In an example, data analyzer 816 may analyze one or more aggregated data logs of verified data generated by data log aggregator 814. In some embodiments, data analyzer 816 stores analysis results in a data table structure to permit fast queries of metadata associated with verified data. For example, data analyzer 816 may compute a quantity of verified data records for each type of data, a sum of verified data records for each type of data where the data type permits numerical computation, or other statistical analyses. In some embodiments, data analyzer 816 performs the data analysis functionality described with respect to FIG. 5B.

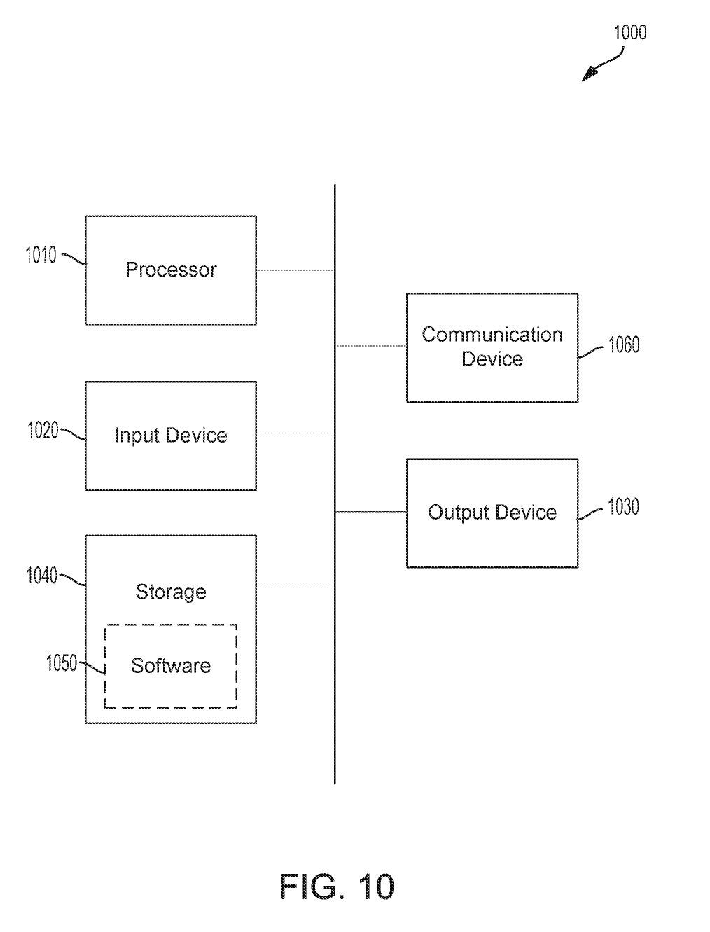

FIG. 10 illustrates an example of a computer in accordance with one embodiment. Computer 1000 can be a component of a system for providing scalable data verification with immutable, redundant data storage according to the systems and methods described above or can include the entire system itself such as client systems 108A-C, service system 106, and verification system 104 from FIG. 1. In some embodiments, computer 1000 is configured to execute a method for providing scalable data verification, such as each of methods 600 and 700 of FIGS. 6A-B and 7, respectively.

Computer 1000 can be a host computer connected to a network. Computer 1000 can be a client computer or a server. As shown in FIG. 10, computer 1000 can be any suitable type of microprocessor-based device, such as a personal computer, workstation, server, Internet Of Things device, or handheld computing device, such as a phone or tablet. The computer can include, for example, one or more of processor 1010, input device 1020, output device 1030, storage 1040, and communication device 1060. Input device 1020 and output device 1030 can generally correspond to those described above and can either be connectable or integrated with the computer.

Input device 1020 can be any suitable device that provides input, such as a touch screen or monitor, keyboard, mouse, or voice-recognition device. Output device 1030 can be any suitable device that provides output, such as a touch screen, monitor, printer, disk drive, or speaker.

Storage 1040 can be any suitable device that provides storage, such as an electrical, magnetic, or optical memory, including a RAM, cache, hard drive, CD-ROM drive, tape drive, or removable storage disk. Communication device 1060 can include any suitable device capable of transmitting and receiving signals over a network, such as a network interface chip or card. The components of the computer can be connected in any suitable manner, such as via a physical bus or wirelessly. Storage 1040 can be a non-transitory computer-readable storage medium comprising one or more programs, which, when executed by one or more processors, such as processor 1010, cause the one or more processors to execute methods described herein, such as each of methods 600 and 700 of FIGS. 6A-B and 7, respectively.

Software 1050, which can be stored in storage 1040 and executed by processor 1010, can include, for example, the programming that embodies the functionality of the present disclosure (e.g., as embodied in the systems, computers, servers, and/or devices as described above). In some embodiments, software 1050 can include a combination of servers such as application servers and database servers.

Software 1050 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 1040, that can contain or store programming for use by or in connection with an instruction execution system, apparatus, or device.

Software 1050 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 1000 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 1000 can implement any operating system suitable for operating on the network. Software 1050 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The techniques, methods, systems, devices, and/or other aspects disclosed herein may, in some embodiments, include one or more of the following enumerated embodiments, in whole or in part. As would be apparent to a person of skill in the art in light of the disclosures herein, the following enumerated embodiments may optionally be combined in any suitable combination, including by incorporating one or more elements of any of the dependent embodiments below with any of the independent embodiments (even if such dependency is not explicitly indicated below). Features from the independent enumerated embodiments below may also be combined with one another.
1. A non-transitory computer-readable storage medium comprising instructions for providing scalable data verification, wherein the instructions, when executed by a first device having one or more processors, cause the one or more processors to:
   receive first data associated with a second device;
   determine whether a first hash value generated by hashing the first data matches a second hash value, wherein the second hash value is received from a second device and represents a hash of second data stored at the second device;
   in response to determining that the first and second hash values match, store the first data and the first hash value to a first data log at the first device, wherein the first data log is associated with the second device;
   determine whether a third hash value generated by hashing the first data log matches a fourth hash value, wherein the fourth hash value is received from the second device and represents a hash of a second data log stored at the second device; and
   in response to determining that the third and fourth hash values match, update a verification log to indicate that the first and second data logs match.
2. The non-transitory computer-readable storage medium of embodiment 1, wherein the instructions cause the one or more processors to:
hash the first data to generate the first hash value based on a predetermined hashing algorithm, wherein the second hash value represents a hash of the second data generated based on the predetermined hashing algorithm.
3. The non-transitory computer-readable storage medium of any of embodiments 1-2, wherein the receiving comprises:

receiving the first data from the second device.
4. The non-transitory computer-readable storage medium of any of embodiments 1-3, wherein the first data log is associated with only the first and second devices.
5. The non-transitory computer-readable storage medium of any of embodiments 1-4, wherein the instructions cause the one or more processors to:

transmit a message to the second device, wherein the message requests the second device to verify that the second data log matches the first data log.
6. The non-transitory computer-readable storage medium of any of embodiments 1-5, wherein the transmitting the message comprises:

transmitting the message based on at least one of a passage of a predetermined period of time, a receipt of a request to verify the first data log, a predetermined number of occurrences of previously-verified data, a size of the first data log reaching a predetermined data size, or any combination thereof.
7. The non-transitory computer-readable storage medium of any of embodiments 1-6, wherein the determining whether the third hash value matches the fourth hash value comprises:

generating the third hash value based on at least one of an occurrence of the first data being stored in the first data log, a passage of a predetermined period of time, a receipt of a request to verify the first data log, a predetermined number of occurrences of previously-verified data, a size of the first data log reaching a predetermined data size, or any combination thereof.
8. The non-transitory computer-readable storage medium of any of embodiments 1-7, wherein the instructions cause the one or more processors to:

configure the first device to hash the first data log using a first hash algorithm; and

hash the first data log with a second hash algorithm based on at least one of a passage of a predetermined period of time, a receipt of a request to use the second hashing algorithm, a predetermined number of occurrences of previously-verified data, a size of the first data log reaching a predetermined data size, or any combination thereof.
9. The non-transitory computer-readable storage medium of any of embodiments 1-8, wherein the first data includes an electronic file.
10. The non-transitory computer-readable storage medium of any of embodiments 1-9, wherein the first and second data each include information indicating the first and second entities.
11. The non-transitory computer-readable storage medium of any of embodiments 1-10, wherein the instructions cause the one or more processors to:

maintain the first data log and a third data log, wherein the first and third data logs are each associated with a unique pair of entities; and

aggregate a first portion of data from the first data log and a second portion of data from the third data log into an aggregated data log.
12. The non-transitory computer-readable storage medium of any of embodiments 1-11, wherein the first and second portions of data are associated with the same type of data.
13. The non-transitory computer-readable storage medium of any of embodiments 1-12, wherein the instructions cause the one or more processors to:

maintain a plurality of data logs with each data log being associated with a unique pair of entities;

aggregate data stored in the plurality of data logs by a plurality of data types; and

store the aggregated data into an aggregated data log.
14. The non-transitory computer-readable storage medium of any of embodiments 1-13, wherein the instructions cause the one or more processors to:

analyze the aggregated data log to generate a plurality of statistics associated with verified data stored in the aggregated data log.
15. The non-transitory computer-readable storage medium of any of embodiments 1-14, wherein the instructions cause the one or more processors to:

coordinate with the second device to create a first new data log for storing future verified data, wherein the coordinating causes the second device to create a second new log corresponding to the first new data log.
16. The non-transitory computer-readable storage medium of any of embodiments 1-15, wherein the instructions cause the one or more processors to:

generate a new data log for storing future verified data;

hash the first data log to generate a hash value to initialize the new data log; and

store the hash value in the new data log.
17. The non-transitory computer-readable storage medium of any of embodiments 1-16, wherein the generating the new data log comprises:

generating the new data log based on at least one of a passage of a predetermined period of time, a current date, a receipt of a request to create the new data log, a predetermined number of occurrences of previously-verified data, a size of the first data log reaching a predetermined data size, or any combination thereof.
18. The non-transitory computer-readable storage medium of any of embodiments 1-17, wherein the generating the new data log comprises:

generating the new data log based on a request received from the second device.
19. The non-transitory computer-readable storage medium of any of embodiments 1-18, wherein the instructions cause the one or more processors to:

in response to determining that the first and second hash values do not match, update the verification log to indicate that the first and second data do not match.
20. The non-transitory computer-readable storage medium of any of embodiments 1-19, wherein the instructions cause the one or more processors to:

in response to determining that the third and fourth hash values do not match, delete the first data and the first hash value from the first data log; and

update the verification log to indicate that the first and second data do not match.
21. The non-transitory computer-readable storage medium of any of embodiments 1-20, wherein the instructions cause the one or more processors to:
   receive from the second device a digital signature associated with the second hash value;

authenticate the second hash value based on the received digital signature; and

wherein the storing the first data and the first hash value to the first data log is performed in response to the authenticating the second hash value.
22. A system for providing scalable data verification, the system comprising a first device comprising one or more processors, memory, and one or more programs stored in the memory and configured to be executed by the one or more processors, the one or more programs including instructions for:
   receiving first data associated with a second device;
   determining whether a first hash value generated by hashing the first data matches a second hash value, wherein the second hash value is received from a second device and represents a hash of second data stored at the second device;
   in response to determining that the first and second hash values match, storing the first data and the first hash value to a first data log at the first device, wherein the first data log is associated with the second device;
   determining whether a third hash value generated by hashing the first data log matches a fourth hash value, wherein the fourth hash value is received from the second device and represents a hash of a second data log stored at the second device; and

in response to determining that the third and fourth hash values match, updating a verification log to indicate that the first and second data logs match.
23. The system of embodiment 22, wherein the instructions comprise:

hashing the first data to generate the first hash value based on a predetermined hashing algorithm, wherein the second hash value represents a hash of the second data generated based on the predetermined hashing algorithm.
24. The system of any of embodiments 22-23, wherein the receiving comprises:

receiving the first data from the second device.
25. The system of any of embodiments 22-24, wherein the first data log is associated with only the first and second devices.
26. The system of any of embodiments 22-25, wherein the instructions comprise:

transmitting a message to the second device, wherein the message requests the second device to verify that the second data log matches the first data log.
27. The system of any of embodiments 22-26, wherein the transmitting the message comprises:

transmitting the message based on at least one of a passage of a predetermined period of time, a receipt of a request to verify the first data log, a predetermined number of occurrences of previously-verified data, a size of the first data log reaching a predetermined data size, or any combination thereof.
28. The system of any of embodiments 22-27, wherein the determining whether the third hash value matches the fourth hash value comprises:

generating the third hash value based on at least one of an occurrence of the first data being stored in the first data log, a passage of a predetermined period of time, a receipt of a request to verify the first data log, a predetermined number of occurrences of previously-verified data, a size of the first data log reaching a predetermined data size, or any combination thereof.
29. The system of any of embodiments 22-28, wherein the instructions comprise:

configuring the first device to hash the first data log using a first hash algorithm; and

hashing the first data log with a second hash algorithm based on at least one of a passage of a predetermined period of time, a receipt of a request to use the second hashing algorithm, a predetermined number of occurrences of previously-verified data, a size of the first data log reaching a predetermined data size, or any combination thereof.
30. The system of any of embodiments 22-29, wherein the first data includes an electronic file.
31. The system of any of embodiments 22-30, wherein the first and second data each include information indicating the first and second entities.
32. The system of any of embodiments 22-31, wherein the instructions comprise:

maintaining the first data log and a third data log, wherein the first and third data logs are each associated with a unique pair of entities; and

aggregating a first portion of data from the first data log and a second portion of data from the third data log into an aggregated data log.
33. The system of any of embodiments 22-32, wherein the first and second portions of data are associated with the same type of data.
34. The system of any of embodiments 22-33, wherein the instructions comprise:

maintaining a plurality of data logs with each data log being associated with a unique pair of entities;

aggregating data stored in the plurality of data logs by a plurality of data types; and

storing the aggregated data into an aggregated data log.
35. The system of any of embodiments 22-34, wherein the instructions comprise:

analyzing the aggregated data log to generate a plurality of statistics associated with verified data stored in the aggregated data log.
36. The system of any of embodiments 22-35, wherein the instructions comprise:

coordinating with the second device to create a first new data log for storing future verified data, wherein the coordinating causes the second device to create a second new log corresponding to the first new data log.
37. The system of any of embodiments 22-36, wherein the instructions comprise:

generating a new data log for storing future verified data;

hashing the first data log to generate a hash value to initialize the new data log; and

storing the hash value in the new data log.
38. The system of any of embodiments 22-37, wherein the generating the new data log comprises:

generating the new data log based on at least one of a passage of a predetermined period of time, a current date, a receipt of a request to create the new data log, a predetermined number of occurrences of previously-verified data, a size of the first data log reaching a predetermined data size, or any combination thereof.
39. The system of any of embodiments 22-38, wherein the generating the new data log comprises:

generating the new data log based on a request received from the second device.
40. The system of any of embodiments 22-39, wherein the instructions comprise:

in response to determining that the first and second hash values do not match, updating the verification log to indicate that the first and second data do not match.
41. The system of any of embodiments 22-30, wherein the instructions comprise:

in response to determining that the third and fourth hash values do not match, deleting the first data and the first hash value from the first data log; and

updating the verification log to indicate that the first and second data do not match.
42. The system of any of embodiments 22-41, wherein the instructions comprise:

receiving from the second device a digital signature associated with the second hash value;

authenticating the second hash value based on the received digital signature; and

wherein the storing the first data and the first hash value to the first data log is performed in response to the authenticating the second hash value.
43. A method performed at a first device to enable scalable data verification, comprising:
   receiving first data associated with a second device;
   determining whether a first hash value generated by hashing the first data matches a second hash value, wherein the second hash value is received from a second device and represents a hash of second data stored at the second device;
   in response to determining that the first and second hash values match, storing the first data and the first hash value to a first data log at the first device, wherein the first data log is associated with the second device;
   determining whether a third hash value generated by hashing the first data log matches a fourth hash value, wherein the fourth hash value is received from the second device and represents a hash of a second data log stored at the second device; and
   in response to determining that the third and fourth hash values match, updating a verification log to indicate that the first and second data logs match.
44. The method of embodiment 43, wherein the method comprises:

hashing the first data to generate the first hash value based on a predetermined hashing algorithm, wherein the second hash value represents a hash of the second data generated based on the predetermined hashing algorithm.
45. The method of any of embodiments 43-44, wherein the receiving comprises:

receiving the first data from the second device.
46. The method of any of embodiments 43-45, wherein the first data log is associated with only the first and second devices.
47. The method of any of embodiments 43-46, wherein the method comprises:

transmitting a message to the second device, wherein the message requests the second device to verify that the second data log matches the first data log.
48. The method of any of embodiments 43-47, wherein the transmitting the message comprises:

transmitting the message based on at least one of a passage of a predetermined period of time, a receipt of a request to verify the first data log, a predetermined number of occurrences of previously-verified data, a size of the first data log reaching a predetermined data size, or any combination thereof.
49. The method of any of embodiments 43-48, wherein the determining whether the third hash value matches the fourth hash value comprises:

generating the third hash value based on at least one of an occurrence of the first data being stored in the first data log, a passage of a predetermined period of time, a receipt of a request to verify the first data log, a predetermined number of occurrences of previously-verified data, a size of the first data log reaching a predetermined data size, or any combination thereof.
50. The method of any of embodiments 43-49, wherein the method comprises:

configuring the first device to hash the first data log using a first hash algorithm; and

hashing the first data log with a second hash algorithm based on at least one of a passage of a predetermined period of time, a receipt of a request to use the second hashing algorithm, a predetermined number of occurrences of previously-verified data, a size of the first data log reaching a predetermined data size, or any combination thereof.
51. The method of any of embodiments 43-50, wherein the first data includes an electronic file.
52. The method of any of embodiments 43-51, wherein the first and second data each include information indicating the first and second entities.
53. The method of any of embodiments 43-52, wherein the method comprises:

maintaining the first data log and a third data log, wherein the first and third data logs are each associated with a unique pair of entities; and

aggregating a first portion of data from the first data log and a second portion of data from the third data log into an aggregated data log.
54. The method of any of embodiments 43-53, wherein the first and second portions of data are associated with the same type of data.
55. The method of any of embodiments 43-54, wherein the method comprises:

maintaining a plurality of data logs with each data log being associated with a unique pair of entities;

aggregating data stored in the plurality of data logs by a plurality of data types; and

storing the aggregated data into an aggregated data log.
56. The method of any of embodiments 43-55, wherein the method comprises:

analyzing the aggregated data log to generate a plurality of statistics associated with verified data stored in the aggregated data log.
57. The method of any of embodiments 43-56, wherein the method comprises:

coordinating with the second device to create a first new data log for storing future verified data, wherein the coordinating causes the second device to create a second new log corresponding to the first new data log.
58. The method of any of embodiments 43-57, wherein the method comprises:

generating a new data log for storing future verified data;

hashing the first data log to generate a hash value to initialize the new data log; and

storing the hash value in the new data log.
59. The method of any of embodiments 43-58, wherein the generating the new data log comprises:

generating the new data log based on at least one of a passage of a predetermined period of time, a current date, a receipt of a request to create the new data log, a predetermined number of occurrences of previously-verified data, a size of the first data log reaching a predetermined data size, or any combination thereof.
60. The method of any of embodiments 43-59, wherein the generating the new data log comprises:

generating the new data log based on a request received from the second device.
61. The method of any of embodiments 43-60, wherein the method comprises:

in response to determining that the first and second hash values do not match, updating the verification log to indicate that the first and second data do not match.
62. The method of any of embodiments 43-61, wherein the method comprises:

in response to determining that the third and fourth hash values do not match, deleting the first data and the first hash value from the first data log; and

updating the verification log to indicate that the first and second data do not match.
63. The method of any of embodiments 43-62, wherein the method comprises:

receiving from the second device a digital signature associated with the second hash value;

authenticating the second hash value based on the received digital signature; and
wherein the storing the first data and the first hash value to the first data log is performed in response to the authenticating the second hash value.

The foregoing description, for purpose of explanation, has been described with reference to specific embodiments. The illustrative embodiments described above, however, are not intended to be exhaustive or to limit the disclosure to the precise forms disclosed. Many modifications and variations are possible in view of the above teachings. The embodiments were chosen and described to best explain the principles of the disclosed techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

What is claimed is:

1. A non-transitory computer-readable storage medium comprising instructions for providing scalable data verification, wherein the instructions, when executed by a first device having one or more processors, cause the one or more processors to:
receive first data associated with a second device;
determine whether a first hash value generated by hashing the first data matches a second hash value, wherein the second hash value is received from a second device and represents a hash of second data stored at the second device;
in response to determining that the first and second hash values match, store the first data and the first hash value to a first data log at the first device, wherein the first data log is associated with the second device;
determine whether a third hash value generated by hashing the first data log matches a fourth hash value, wherein the fourth hash value is received from the second device and represents a hash of a second data log stored at the second device; and
in response to determining that the third and fourth hash values match, update a verification log to indicate that the first and second data logs match.

2. The non-transitory computer-readable storage medium of claim 1, wherein the instructions cause the one or more processors to:
hash the first data to generate the first hash value based on a predetermined hashing algorithm, wherein the second hash value represents a hash of the second data generated based on the predetermined hashing algorithm.

3. The non-transitory computer-readable storage medium of claim 1, wherein the receiving comprises:
receiving the first data from the second device.

4. The non-transitory computer-readable storage medium of claim 1, wherein the first data log is associated with only the first and second devices.

5. The non-transitory computer-readable storage medium of claim 1, wherein the instructions cause the one or more processors to:
transmit a message to the second device, wherein the message requests the second device to verify that the second data log matches the first data log.

6. The non-transitory computer-readable storage medium of claim 5, wherein the transmitting the message comprises:
transmitting the message based on at least one of a passage of a predetermined period of time, a receipt of a request to verify the first data log, a predetermined number of occurrences of previously-verified data, a size of the first data log reaching a predetermined data size, or any combination thereof.

7. The non-transitory computer-readable storage medium of claim 1, wherein the determining whether the third hash value matches the fourth hash value comprises:
generating the third hash value based on at least one of an occurrence of the first data being stored in the first data log, a passage of a predetermined period of time, a receipt of a request to verify the first data log, a predetermined number of occurrences of previously-verified data, a size of the first data log reaching a predetermined data size, or any combination thereof.

8. The non-transitory computer-readable storage medium of claim 1, wherein the instructions cause the one or more processors to:
configure the first device to hash the first data log using a first hash algorithm; and
hash the first data log with a second hash algorithm based on at least one of a passage of a predetermined period of time, a receipt of a request to use the second hashing algorithm, a predetermined number of occurrences of previously-verified data, a size of the first data log reaching a predetermined data size, or any combination thereof.

9. The non-transitory computer-readable storage medium of claim 1, wherein the first data includes an electronic file.

10. The non-transitory computer-readable storage medium of claim 1, wherein the first and second data each include information indicating the first and second entities.

11. The non-transitory computer-readable storage medium of claim 1, wherein the instructions cause the one or more processors to:
maintain the first data log and a third data log, wherein the first and third data logs are each associated with a unique pair of entities; and
aggregate a first portion of data from the first data log and a second portion of data from the third data log into an aggregated data log.

12. The non-transitory computer-readable storage medium of claim 11, wherein the first and second portions of data are associated with the same type of data.

13. The non-transitory computer-readable storage medium of claim 1, wherein the instructions cause the one or more processors to:
maintain a plurality of data logs with each data log being associated with a unique pair of entities;
aggregate data stored in the plurality of data logs by a plurality of data types; and
store the aggregated data into an aggregated data log.

14. The non-transitory computer-readable storage medium of claim 13, wherein the instructions cause the one or more processors to:
analyze the aggregated data log to generate a plurality of statistics associated with verified data stored in the aggregated data log.

15. The non-transitory computer-readable storage medium of claim 1, wherein the instructions cause the one or more processors to:
coordinate with the second device to create a first new data log for storing future verified data, wherein the coordinating causes the second device to create a second new log corresponding to the first new data log.

16. The non-transitory computer-readable storage medium of claim 1, wherein the instructions cause the one or more processors to:
generate a new data log for storing future verified data;
hash the first data log to generate a hash value to initialize the new data log; and
store the hash value in the new data log.

17. The non-transitory computer-readable storage medium of claim 16, wherein the generating the new data log comprises:
generating the new data log based on at least one of a passage of a predetermined period of time, a current date, a receipt of a request to create the new data log, a predetermined number of occurrences of previously-verified data, a size of the first data log reaching a predetermined data size, or any combination thereof.

18. The non-transitory computer-readable storage medium of claim 16, wherein the generating the new data log comprises:
generating the new data log based on a request received from the second device.

19. The non-transitory computer-readable storage medium of claim 1, wherein the instructions cause the one or more processors to:
in response to determining that the first and second hash values do not match, update the verification log to indicate that the first and second data do not match.

20. The non-transitory computer-readable storage medium of claim 1, wherein the instructions cause the one or more processors to:
in response to determining that the third and fourth hash values do not match, delete the first data and the first hash value from the first data log; and
update the verification log to indicate that the first and second data do not match.

21. The non-transitory computer-readable storage medium of claim 1, wherein the instructions cause the one or more processors to:
receive from the second device a digital signature associated with the second hash value;
authenticate the second hash value based on the received digital signature; and
wherein the storing the first data and the first hash value to the first data log is performed in response to the authenticating the second hash value.

22. A system for providing scalable data verification, the system comprising a first device comprising one or more processors, memory, and one or more programs stored in the memory and configured to be executed by the one or more processors, the one or more programs including instructions for:
receiving first data associated with a second device;
determining whether a first hash value generated by hashing the first data matches a second hash value, wherein the second hash value is received from a second device and represents a hash of second data stored at the second device;
in response to determining that the first and second hash values match, storing the first data and the first hash value to a first data log at the first device, wherein the first data log is associated with the second device;
determining whether a third hash value generated by hashing the first data log matches a fourth hash value, wherein the fourth hash value is received from the second device and represents a hash of a second data log stored at the second device; and
in response to determining that the third and fourth hash values match, updating a verification log to indicate that the first and second data logs match.

23. A method performed at a first device to enable scalable data verification, comprising:
receiving first data associated with a second device;
determining whether a first hash value generated by hashing the first data matches a second hash value, wherein the second hash value is received from a second device and represents a hash of second data stored at the second device;
in response to determining that the first and second hash values match, storing the first data and the first hash value to a first data log at the first device, wherein the first data log is associated with the second device;
determining whether a third hash value generated by hashing the first data log matches a fourth hash value, wherein the fourth hash value is received from the second device and represents a hash of a second data log stored at the second device; and
in response to determining that the third and fourth hash values match, updating a verification log to indicate that the first and second data logs match.
